(19) United States
(12) Patent Application Publication
(10) Pub. No.: US 2013/0328925 A1
(43) Pub. Date: Dec. 12, 2013

(54) OBJECT FOCUS IN A MIXED REALITY ENVIRONMENT

(71) Applicants: Stephen G. Latta, Seattle, WA (US); Adam G. Poulos, Redmond, WA (US); Daniel J. McCulloch, Kirkland, WA (US); Jeffrey Cole, Seattle, WA (US); Wei Zhang, Redmond, WA (US)

(72) Inventors: Stephen G. Latta, Seattle, WA (US); Adam G. Poulos, Redmond, WA (US); Daniel J. McCulloch, Kirkland, WA (US); Jeffrey Cole, Seattle, WA (US); Wei Zhang, Redmond, WA (US)

(21) Appl. No.: 13/494,840

(22) Filed: Jun. 12, 2012

(51) Int. Cl. G09G 5/00

(52) U.S. Cl. 345/633

(57) ABSTRACT

A system and method are disclosed for interpreting user focus on virtual objects in a mixed reality environment. Using inference, express gestures and heuristic rules, the present system determines which of the virtual objects the user is likely focused on and interacting with. At that point, the present system may emphasize the selected virtual object over other virtual objects, and interact with the selected virtual object in a variety of ways.

### BACKGROUND

Mixed reality is a technology that allows virtual imagery to be mixed with a real world physical environment. A see-through, head mounted, mixed reality display device may be worn by a user to view the mixed imagery of real objects and virtual objects displayed in the user's field of view. It may happen that a user has several virtual objects within his field of view, and the user may have the ability to interact with these virtual objects. However, unlike real world objects, there is no physical contact to indicate which of the virtual objects the user wishes to interact with. An intuitive system is needed that is able to determine which of the virtual objects the user is most likely focused on and interacting with.

### SUMMARY

Embodiments of the present technology relate to a system and method for interpreting user focus on virtual objects in a mixed reality environment. A system for creating a mixed reality environment in general includes a see-through, head mounted display device coupled to one or more processing units. The processing units in cooperation with the head mounted display unit(s) are able to display one or more virtual objects, also referred to as holographic objects, to the user. The user may have the ability to interact with the displayed virtual objects.

Using inference, express gestures and heuristic rules, the present system determines which of the virtual objects the user is likely focused on and interacting with. At that point, the present system may emphasize the selected virtual object over other virtual objects, and interact with the selected virtual object in a variety of ways.

In an example, the present technology relates to a system for presenting a mixed reality experience to one or more users, the system comprising: a display device for a user, the display device including a display unit for displaying one or more virtual images to the user of the display device; and a computing system operatively coupled to the one or more display devices, the computing system generating the one or more virtual images for display on the display device, the computing system determining selection of a virtual image from the one or more virtual images by inferring interaction of the user with the virtual image based on at least one of determining a position of the user's head with respect to the virtual image, determining a position of the user's eyes with respect to the virtual image, determining a position of the user's hand with respect to the virtual image, and determining movement of the user's hand with respect to the virtual image.

In another example, the present technology relates to a method of presenting a mixed reality experience to one or more users, the method comprising: (a) displaying first and second virtual objects to a user in the user's field of view; (b) determining at least one of a position of the user's hand and a position of the user's head; (c) inferring selection of the first virtual object based on the determination of said step (b); and (d) deemphasizing the second virtual object relative to the first virtual object upon inferring selection of the first virtual object in said step (c).

In a further example, the present technology relates to a method of presenting a mixed reality experience to one or more users, the method comprising: (a) displaying first and second virtual objects to a user in the user's field of view; (b) setting the first virtual object as the object on which the user is focused upon determining the user has performed an express gesture indicating selection of the first virtual object; (c) setting the first virtual object as the object on which the user is focused upon determining the user is pointing at the first virtual object for a predetermined period of time; (d) setting the first virtual object as the object on which the user is focused upon determining the user's head is facing in a direction of the first virtual object; and (e) deemphasizing the second virtual object relative to the first virtual object upon setting the first virtual object as the object on which the user is focused in one of said steps (b), (c) and (d).

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is an illustration of example components of one embodiment of a system for presenting a mixed reality environment to one or more users.

FIG. 2 is a perspective view of one embodiment of a head mounted display unit.

FIG. 3 is a side view of a portion of one embodiment of a head mounted display unit.

FIG. 4 is a block diagram of one embodiment of the components of a head mounted display unit.

FIG. 5 is a block diagram of one embodiment of the components of a processing unit associated with a head mounted display unit.

FIG. 6 is a block diagram of one embodiment of the components of a hub computing system used with a head mounted display unit.

FIG. 7 is a block diagram of one embodiment of a computing system that can be used to implement the hub computing system described herein.

FIG. 8 is an illustration of an example of a mixed reality environment including a display of a virtual object selected by a user.

FIG. 9 is a flowchart showing the operation and collaboration of the hub computing system, one or more processing units and one or more head mounted display units of the present system.

FIGS. 10-16A are more detailed flowcharts of examples of various steps shown in the flowchart of FIG. 9.

### DETAILED DESCRIPTION

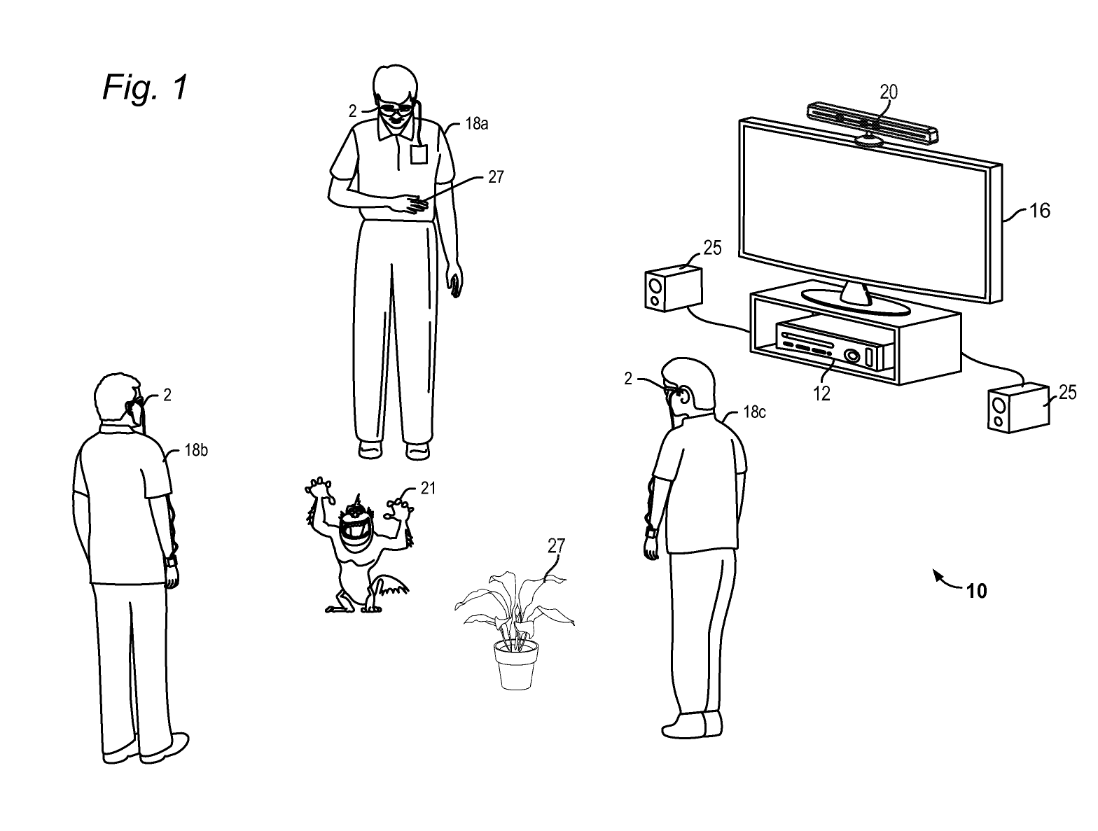

Embodiments of the present technology will now be described with reference to FIGS. 1-16A, which in general relate to a mixed reality environment wherein user focus on virtual objects may be determined using inference, gestures and heuristics. The system for implementing the mixed reality environment includes a mobile display device communicating with a hub computing system. The mobile display device may include a mobile processing unit coupled to a head mounted display device (or other suitable apparatus) having a display element.

Each user wears a head mounted display device including a display element. The display element is to a degree transparent so that a user can look through the display element at real world objects within the user's field of view (FOV). The display element also provides the ability to project virtual images into the FOV of the user such that the virtual images may also appear alongside the real world objects. The system automatically tracks where the user is looking so that the system can determine where to insert the virtual image in the FOV of the user. Once the system knows where to project the virtual image, the image is projected using the display element.

In embodiments, the hub computing system and one or more of the processing units may cooperate to build a model of the environment including the x, y, z Cartesian positions of all users, real world objects and virtual three-dimensional objects in the room or other environment. The positions of each head mounted display device worn by the users in the environment may be calibrated to the model of the environment and to each other. This allows the system to determine each user's line of sight and FOV of the environment. Thus, a virtual image may be displayed to each user, but the system determines the display of the virtual image from each user's perspective, adjusting the virtual image for parallax and any occlusions from or by other objects in the environment. The model of the environment, referred to herein as a scene map, as well as all tracking of each user's FOV and objects in the environment may be generated by the hub computing system and processing unit working in tandem or individually.

A user may choose to interact with one or more of the virtual objects appearing within the user's FOV. As used herein, the term “interact” encompasses both physical interaction and verbal interaction of a user with a virtual object. Physical interaction includes a user performing a predefined gesture using his or her fingers, hand and/or other body part(s) recognized by the mixed reality system as a user-request for the system to perform a predefined action. Such predefined gestures may include, but are not limited to, pointing at, grabbing, and pushing virtual objects.

A user may also physically interact with a virtual object with his or her eyes. In some instances, eye gaze data identifies where a user is focusing in the FOV, and can thus identify that a user is looking at a particular virtual object. Sustained eye gaze, or a blink or blink sequence, may thus be a physical interaction whereby a user selects one or more virtual objects. A user simply looking at a virtual object, such as viewing content on a virtual display slate, is a further example of physical interaction of a user with a virtual object.

A user may alternatively or additionally interact with virtual objects using verbal gestures, such as for example a spoken word or phrase recognized by the mixed reality system as a user request for the system to perform a predefined action. Verbal gestures may be used in conjunction with physical gestures to interact with one or more virtual objects in the mixed reality environment.

In accordance with the present technology, when multiple virtual objects are displayed, the present system determines which of the virtual objects the user is focused on. That virtual object is then available for interaction and the other virtual objects may, optionally, be deemphasized by various methods. The present technology uses various schemes for determining user focus. In one example, the system may receive a predefined selection gesture indicating that the user is selecting a given virtual object. Alternatively, the system may receive a predefined interaction gesture, where the user indicates a focus by interacting with a given virtual object. Both the selection gesture and the interaction gestures may be physical or verbal. In a further example, the system may track the user's head and/or eye positions to determine where the user is looking. The system may then select a virtual object based on where the user is looking according to various heuristic rules.

Embodiments are described below which identify user focus on a virtual object such as a virtual display slate presenting content to a user. The content may be any content which can be displayed on the virtual slate, including for example static content such as text and pictures or dynamic content such as video. However, it is understood that the present technology is not limited to identifying user focus on virtual display slates, and may identify user focus on any virtual objects with which a user may interact.

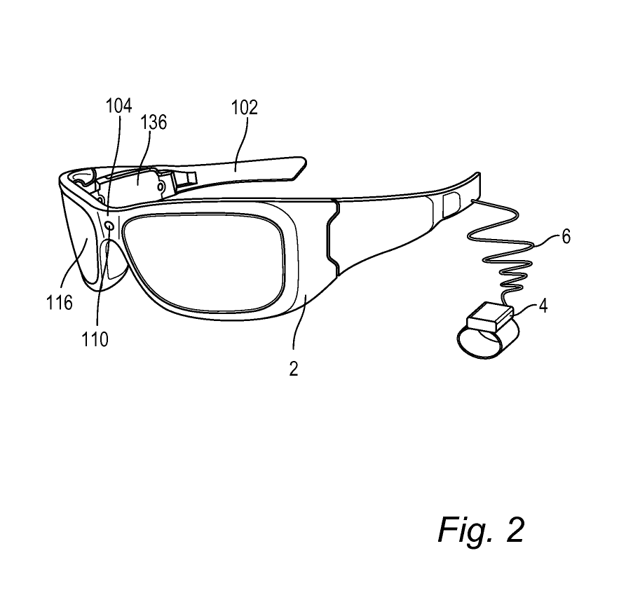

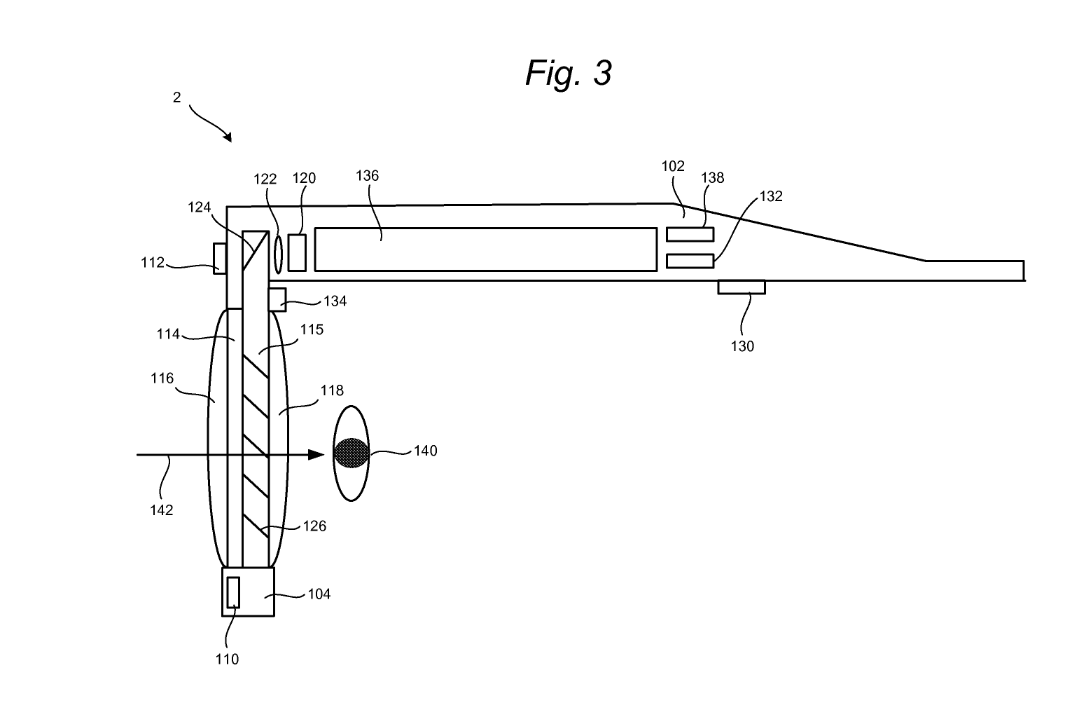

FIG. 1 illustrates a system 10 for providing a mixed reality experience by fusing virtual content 21 into real content 27 within a user's FOV. FIG. 1 shows a number of users 18a, 18b and 18c each wearing a head mounted display device 2. As seen in FIGS. 2 and 3, each head mounted display device 2 is in communication with its own processing unit 4 via wire 6. In other embodiments, head mounted display device 2 communicates with processing unit 4 via wireless communication. Head mounted display device 2, which in one embodiment is in the shape of glasses, is worn on the head of a user so that the user can see through a display and thereby have an actual direct view of the space in front of the user. The use of the term “actual direct view” refers to the ability to see the real world objects directly with the human eye, rather than seeing created image representations of the objects. For example, looking through glass at a room allows a user to have an actual direct view of the room, while viewing a video of a room on a television is not an actual direct view of the room. More details of the head mounted display device 2 are provided below.

In one embodiment, processing unit 4 is a small, portable device for example worn on the user's wrist or stored within a user's pocket. The processing unit may for example be the size and form factor of a cellular telephone, though it may be other shapes and sizes in further examples. The processing unit 4 may include much of the computing power used to operate head mounted display device 2. In embodiments, the processing unit 4 communicates wirelessly (e.g., WiFi, Bluetooth, infra-red, or other wireless communication means) to one or more hub computing systems 12. As explained hereinafter, hub computing system 12 (also referred to as hub 12) may be omitted in further embodiments to provide a completely mobile mixed reality experience using the head mounted displays and processing units 4.

Hub computing system 12 may be a computer, a gaming system or console, or the like. According to an example embodiment, the hub computing system 12 may include hardware components and/or software components such that hub computing system 12 may be used to execute applications such as gaming applications, non-gaming applications, or the like. In one embodiment, hub computing system 12 may include a processor such as a standardized processor, a specialized processor, a microprocessor, or the like that may execute instructions stored on a processor readable storage device for performing the processes described herein.

Hub computing system 12 further includes a capture device 20 for capturing image data from portions of a scene within its FOV. As used herein, a scene is the environment in which the users move around, which environment is captured within the FOV of the capture device 20 and/or the FOV of each head mounted display device 2. FIG. 1 shows a single capture device 20, but there may be multiple capture devices in further embodiments which cooperate to collectively capture image data from a scene within the composite FOVs of the multiple capture devices 20. Capture device 20 may include one or more cameras that visually monitor the one or more users 18a, 18b, 18c and the surrounding space such that gestures and/or movements performed by the one or more users, as well as the structure of the surrounding space, may be captured, analyzed, and tracked to perform one or more controls or actions within the application and/or animate an avatar or on-screen character.

Hub computing system 12 may be connected to an audiovisual device 16 such as a television, a monitor, a high-definition television (HDTV), or the like that may provide game or application visuals. For example, hub computing system 12 may include a video adapter such as a graphics card and/or an audio adapter such as a sound card that may provide audiovisual signals associated with the game application, non-game application, etc. The audiovisual device 16 may receive the audiovisual signals from hub computing system 12 and may then output the game or application visuals and/or audio associated with the audiovisual signals. According to one embodiment, the audiovisual device 16 may be connected to hub computing system 12 via, for example, an S-Video cable, a coaxial cable, an HDMI cable, a DVI cable, a VGA cable, a component video cable, RCA cables, etc. In one example, audiovisual device 16 includes internal speakers. In other embodiments, audiovisual device 16 and hub computing system 12 may be connected to external speakers 25.

Hub computing system 12, with capture device 20, may be used to recognize, analyze, and/or track human (and other types of) targets. For example, one or more of the users 18a, 18b and 18c wearing head mounted display devices 2 may be tracked using the capture device 20 such that the gestures and/or movements of the users may be captured to animate one or more avatars or on-screen characters. The movements may also or alternatively be interpreted as controls that may be used to affect the application being executed by hub computing system 12. The hub computing system 12, together with the head mounted display devices 2 and processing units 4, may also together provide a mixed reality experience where one or more virtual images, such as virtual image 21 in FIG. 1, may be mixed together with real world objects in a scene. FIG. 1 illustrates examples of a plant 27 or a user's hand 27 as real world objects appearing within the user's FOV.

FIGS. 2 and 3 show perspective and side views of the head mounted display device 2. FIG. 3 shows the right side of head mounted display device 2, including a portion of the device having temple 102 and nose bridge 104. Built into nose bridge 104 is a microphone 110 for recording sounds and transmitting that audio data to processing unit 4, as described below. At the front of head mounted display device 2 is room-facing video camera 112 that can capture video and still images. Those images are transmitted to processing unit 4, as described below.

A portion of the frame of head mounted display device 2 will surround a display (that includes one or more lenses). In order to show the components of head mounted display device 2, a portion of the frame surrounding the display is not depicted. The display includes a light-guide optical element 115, opacity filter 114, see-through lens 116 and see-through lens 118. In one embodiment, opacity filter 114 is behind and aligned with see-through lens 116, light-guide optical element 115 is behind and aligned with opacity filter 114, and see-through lens 118 is behind and aligned with light-guide optical element 115. See-through lenses 116 and 118 are standard lenses used in eye glasses and can be made to any prescription (including no prescription). In one embodiment, see-through lenses 116 and 118 can be replaced by a variable prescription lens. In some embodiments, head mounted display device 2 will include one see-through lens or no see-through lenses. In another alternative, a prescription lens can go inside light-guide optical element 115. Opacity filter 114 filters out natural light (either on a per pixel basis or uniformly) to enhance the contrast of the virtual imagery. Light-guide optical element 115 channels artificial light to the eye. More details of opacity filter 114 and light-guide optical element 115 are provided below.

Mounted to or inside temple 102 is an image source, which (in one embodiment) includes microdisplay 120 for projecting a virtual image and lens 122 for directing images from microdisplay 120 into light-guide optical element 115. In one embodiment, lens 122 is a collimating lens.

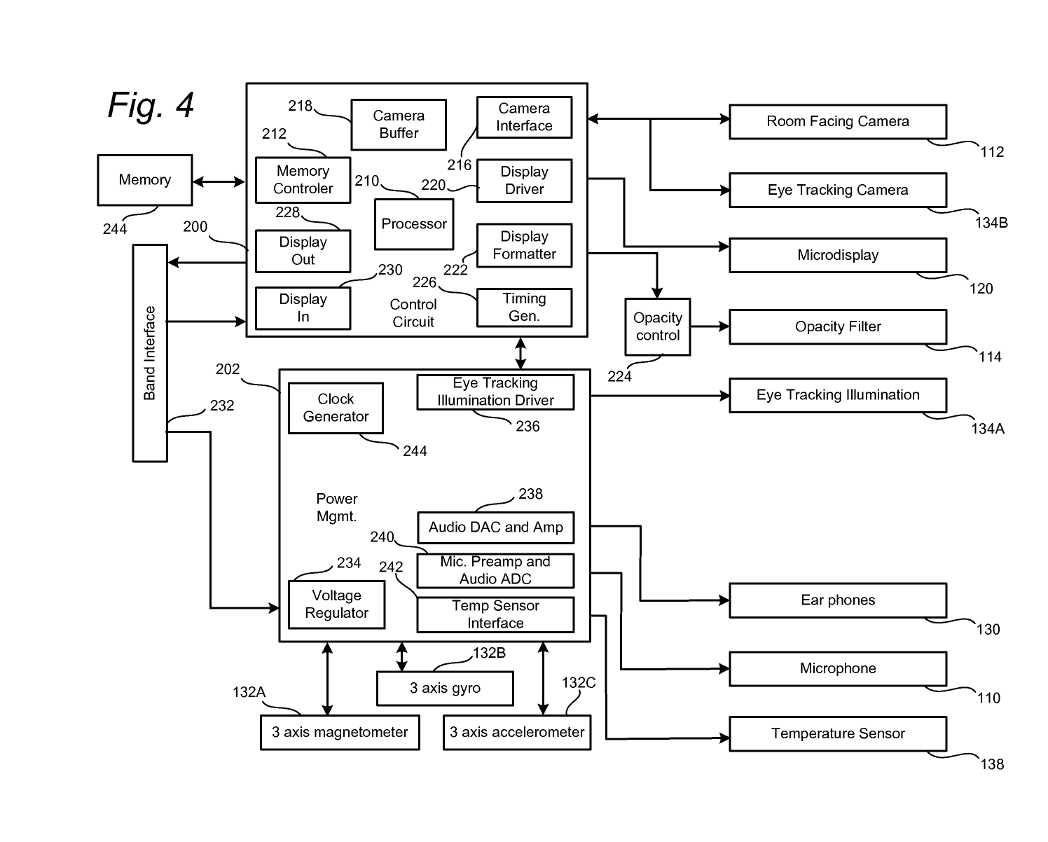

Control circuits 136 provide various electronics that support the other components of head mounted display device 2. More details of control circuits 136 are provided below with respect to FIG. 4. Inside or mounted to temple 102 are ear phones 130, inertial measurement unit 132 and temperature sensor 138. In one embodiment shown in FIG. 4, the inertial measurement unit 132 (or IMU 132) includes inertial sensors such as a three axis magnetometer 132A, three axis gyro 132B and three axis accelerometer 132C. The inertial measurement unit 132 senses position, orientation, and sudden accelerations (pitch, roll and yaw) of head mounted display device 2. The IMU 132 may include other inertial sensors in addition to or instead of magnetometer 132A, gyro 132B and accelerometer 132C.

Microdisplay 120 projects an image through lens 122. There are different image generation technologies that can be used to implement microdisplay 120. For example, microdisplay 120 can be implemented in using a transmissive projection technology where the light source is modulated by optically active material, backlit with white light. These technologies are usually implemented using LCD type displays with powerful backlights and high optical energy densities. Microdisplay 120 can also be implemented using a reflective technology for which external light is reflected and modulated by an optically active material. The illumination is forward lit by either a white source or RGB source, depending on the technology. Digital light processing (DLP), liquid crystal on silicon (LCOS) and Mirasol® display technology from Qualcomm, Inc. are examples of reflective technologies which are efficient as most energy is reflected away from the modulated structure and may be used in the present system. Additionally, microdisplay 120 can be implemented using an emissive technology where light is generated by the display. For example, a PicoP™ display engine from Microvision, Inc. emits a laser signal with a micro mirror steering either onto a tiny screen that acts as a transmissive element or beamed directly into the eye (e.g., laser).

Light-guide optical element 115 transmits light from microdisplay 120 to the eye 140 of the user wearing head mounted display device 2. Light-guide optical element 115 also allows light from in front of the head mounted display device 2 to be transmitted through light-guide optical element 115 to eye 140, as depicted by arrow 142, thereby allowing the user to have an actual direct view of the space in front of head mounted display device 2 in addition to receiving a virtual image from microdisplay 120. Thus, the walls of light-guide optical element 115 are see-through. Light-guide optical element 115 includes a first reflecting surface 124 (e.g., a mirror or other surface). Light from microdisplay 120 passes through lens 122 and becomes incident on reflecting surface 124. The reflecting surface 124 reflects the incident light from the microdisplay 120 such that light is trapped inside a planar substrate comprising light-guide optical element 115 by internal reflection. After several reflections off the surfaces of the substrate, the trapped light waves reach an array of selectively reflecting surfaces 126. Note that one of the five surfaces is labeled 126 to prevent over-crowding of the drawing. Reflecting surfaces 126 couple the light waves incident upon those reflecting surfaces out of the substrate into the eye 140 of the user.

As different light rays will travel and bounce off the inside of the substrate at different angles, the different rays will hit the various reflecting surfaces 126 at different angles. Therefore, different light rays will be reflected out of the substrate by different ones of the reflecting surfaces. The selection of which light rays will be reflected out of the substrate by which surface 126 is engineered by selecting an appropriate angle of the surfaces 126. More details of a light-guide optical element can be found in United States Patent Publication No. 2008/0285140, entitled “Substrate-Guided Optical Devices,” published on Nov. 20, 2008, incorporated herein by reference in its entirety. In one embodiment, each eye will have its own light-guide optical element 115. When the head mounted display device 2 has two light-guide optical elements, each eye can have its own microdisplay 120 that can display the same image in both eyes or different images in the two eyes. In another embodiment, there can be one light-guide optical element which reflects light into both eyes.

Opacity filter 114, which is aligned with light-guide optical element 115, selectively blocks natural light, either uniformly or on a per-pixel basis, from passing through light-guide optical element 115. Details of an example of opacity filter 114 are provided in U.S. Patent Publication No. 2012/0068913 to Bar-Zeev et al., entitled “Opacity Filter For See-Through Mounted Display,” filed on Sep. 21, 2010, incorporated herein by reference in its entirety. However, in general, an embodiment of the opacity filter 114 can be a see-through LCD panel, an electrochromic film, or similar device which is capable of serving as an opacity filter. Opacity filter 114 can include a dense grid of pixels, where the light transmissivity of each pixel is individually controllable between minimum and maximum transmissivities. While a transmissivity range of 0-100% is ideal, more limited ranges are also acceptable, such as for example about 50% to 90% per pixel, up to the resolution of the LCD.

A mask of alpha values can be used from a rendering pipeline, after z-buffering with proxies for real-world objects. When the system renders a scene for the augmented reality display, it takes note of which real-world objects are in front of which virtual objects as explained below. If a virtual object is in front of a real-world object, then the opacity may be on for the coverage area of the virtual object. If the virtual object is (virtually) behind a real-world object, then the opacity may be off, as well as any color for that pixel, so the user will see the real-world object for that corresponding area (a pixel or more in size) of real light. Coverage would be on a pixel-by-pixel basis, so the system could handle the case of part of a virtual object being in front of a real-world object, part of the virtual object being behind the real-world object, and part of the virtual object being coincident with the real-world object. Displays capable of going from 0% to 100% opacity at low cost, power, and weight are the most desirable for this use. Moreover, the opacity filter can be rendered in color, such as with a color LCD or with other displays such as organic LEDs, to provide a wide FOV.

Head mounted display device 2 also includes a system for tracking the position of the user's eyes. As will be explained below, the system will track the user's position and orientation so that the system can determine the FOV of the user. However, a human will not perceive everything in front of them. Instead, a user's eyes will be directed at a subset of the environment. Therefore, in one embodiment, the system will include technology for tracking the position of the user's eyes in order to refine the measurement of the FOV of the user. For example, head mounted display device 2 includes eye tracking assembly 134 (FIG. 3), which has an eye tracking illumination device 134A and eye tracking camera 134B (FIG. 4). In one embodiment, eye tracking illumination device 134A includes one or more infrared (IR) emitters, which emit IR light toward the eye. Eye tracking camera 134B includes one or more cameras that sense the reflected IR light. The position of the pupil can be identified by known imaging techniques which detect the reflection of the cornea. For example, see U.S. Pat. No. 7,401,920, entitled “Head Mounted Eye Tracking and Display System”, issued Jul. 22, 2008, incorporated herein by reference. Such a technique can locate a position of the center of the eye relative to the tracking camera. Generally, eye tracking involves obtaining an image of the eye and using computer vision techniques to determine the location of the pupil within the eye socket. In one embodiment, it is sufficient to track the location of one eye since the eyes usually move in unison. However, it is possible to track each eye separately.

In one embodiment, the system will use four IR LEDs and four IR photo detectors in rectangular arrangement so that there is one IR LED and IR photo detector at each corner of the lens of head mounted display device 2. Light from the LEDs reflect off the eyes. The amount of infrared light detected at each of the four IR photo detectors determines the pupil direction. That is, the amount of white versus black in the eye will determine the amount of light reflected off the eye for that particular photo detector. Thus, the photo detector will have a measure of the amount of white or black in the eye. From the four samples, the system can determine the direction of the eye.

Another alternative is to use four infrared LEDs as discussed above, but one infrared CCD on the side of the lens of head mounted display device 2. The CCD will use a small mirror and/or lens (fish eye) such that the CCD can image up to 75% of the visible eye from the glasses frame. The CCD will then sense an image and use computer vision to find the image, much like as discussed above. Thus, although FIG. 3 shows one assembly with one IR transmitter, the structure of FIG. 3 can be adjusted to have four IR transmitters and/or four IR sensors. More or less than four IR transmitters and/or four IR sensors can also be used.

Another embodiment for tracking the direction of the eyes is based on charge tracking. This concept is based on the observation that a retina carries a measurable positive charge and the cornea has a negative charge. Sensors are mounted by the user's ears (near earphones 130) to detect the electrical potential while the eyes move around and effectively read out what the eyes are doing in real time. Other embodiments for tracking eyes can also be used.

FIG. 3 shows half of the head mounted display device 2. A full head mounted display device would include another set of see-through lenses, another opacity filter, another light-guide optical element, another microdisplay 120, another lens 122, room-facing camera, eye tracking assembly, micro display, earphones, and temperature sensor.

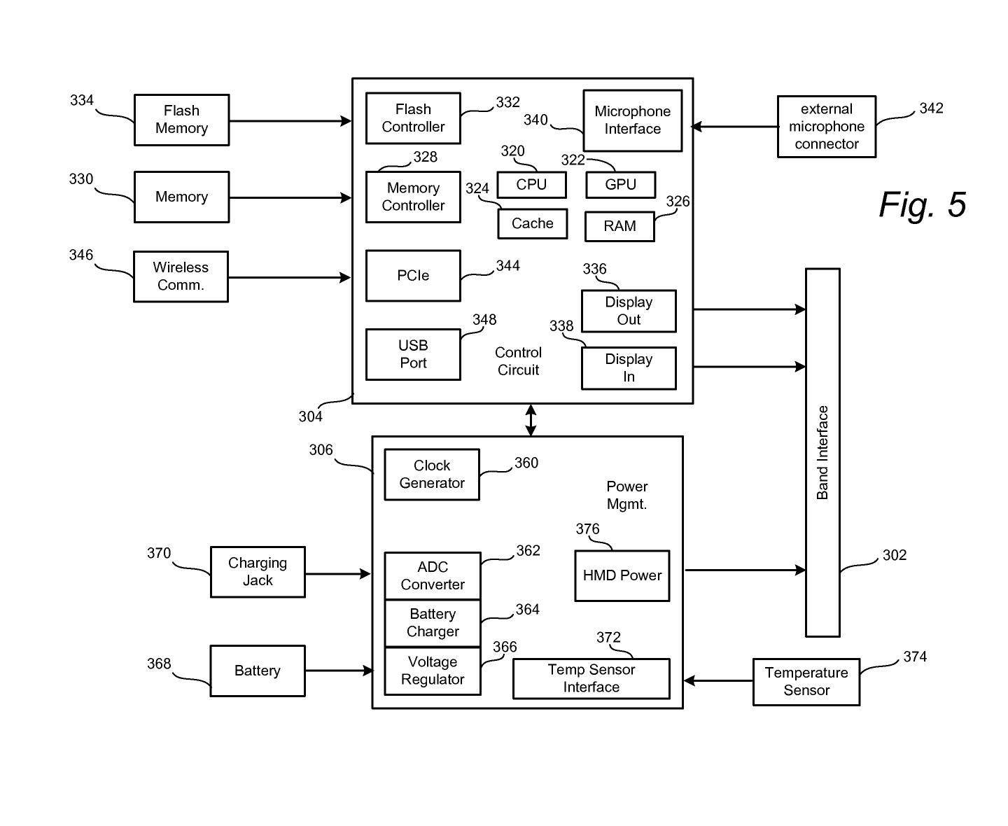

FIG. 4 is a block diagram depicting the various components of head mounted display device 2. FIG. 5 is a block diagram describing the various components of processing unit 4. Head mounted display device 2, the components of which are depicted in FIG. 4, is used to provide a mixed reality experience to the user by fusing one or more virtual images seamlessly with the user's view of the real world. Additionally, the head mounted display device components of FIG. 4 include many sensors that track various conditions. Head mounted display device 2 will receive instructions about the virtual image from processing unit 4 and will provide the sensor information back to processing unit 4. Processing unit 4, the components of which are depicted in FIG. 4, will receive the sensory information from head mounted display device 2 and will exchange information and data with the hub computing system 12 (FIG. 1). Based on that exchange of information and data, processing unit 4 will determine where and when to provide a virtual image to the user and send instructions accordingly to the head mounted display device of FIG. 4.

Some of the components of FIG. 4 (e.g., room-facing camera 112, eye tracking camera 134B, microdisplay 120, opacity filter 114, eye tracking illumination 134A, earphones 130, and temperature sensor 138) are shown in shadow to indicate that there are two of each of those devices, one for the left side and one for the right side of head mounted display device 2. FIG. 4 shows the control circuit 200 in communication with the power management circuit 202. Control circuit 200 includes processor 210, memory controller 212 in communication with memory 214 (e.g., D-RAM), camera interface 216, camera buffer 218, display driver 220, display formatter 222, timing generator 226, display out interface 228, and display in interface 230.

In one embodiment, the components of control circuit 200 are in communication with each other via dedicated lines or one or more buses. In another embodiment, the components of control circuit 200 is in communication with processor 210. Camera interface 216 provides an interface to the two room-facing cameras 112 and stores images received from the room-facing cameras in camera buffer 218. Display driver 220 will drive microdisplay 120. Display formatter 222 provides information, about the virtual image being displayed on microdisplay 120, to opacity control circuit 224, which controls opacity filter 114. Timing generator 226 is used to provide timing data for the system. Display out interface 228 is a buffer for providing images from room-facing cameras 112 to the processing unit 4. Display in interface 230 is a buffer for receiving images such as a virtual image to be displayed on microdisplay 120. Display out interface 228 and display in interface 230 communicate with band interface 232 which is an interface to processing unit 4.

Power management circuit 202 includes voltage regulator 234, eye tracking illumination driver 236, audio DAC and amplifier 238, microphone preamplifier and audio ADC 240, temperature sensor interface 242 and clock generator 244. Voltage regulator 234 receives power from processing unit 4 via band interface 232 and provides that power to the other components of head mounted display device 2. Eye tracking illumination driver 236 provides the IR light source for eye tracking illumination 134A, as described above. Audio DAC and amplifier 238 output audio information to the earphones 130. Microphone preamplifier and audio ADC 240 provides an interface for microphone 110. Temperature sensor interface 242 is an interface for temperature sensor 138. Power management circuit 202 also provides power and receives data back from three axis magnetometer 132A, three axis gyro 132B and three axis accelerometer 132C.

FIG. 5 is a block diagram describing the various components of processing unit 4. FIG. 5 shows control circuit 304 in communication with power management circuit 306. Control circuit 304 includes a central processing unit (CPU) 320, graphics processing unit (GPU) 322, cache 324, RAM 326, memory controller 328 in communication with memory 330 (e.g., D-RAM), flash memory controller 332 in communication with flash memory 334 (or other type of non-volatile storage), display out buffer 336 in communication with head mounted display device 2 via band interface 302 and band interface 232, display in buffer 338 in communication with head mounted display device 2 via band interface 302 and band interface 232, microphone interface 340 in communication with an external microphone connector 342 for connecting to a microphone, PCI express interface for connecting to a wireless communication device 346, and USB port(s) 348. In one embodiment, wireless communication device 346 can include a Wi-Fi enabled communication device, BlueTooth communication device, infrared communication device, etc. The USB port can be used to dock the processing unit 4 to hub computing system 12 in order to load data or software onto processing unit 4, as well as charge processing unit 4. In one embodiment, CPU 320 and GPU 322 are the main workhorses for determining where, when and how to insert virtual three-dimensional objects into the view of the user. More details are provided below.

Power management circuit 306 includes clock generator 360, analog to digital converter 362, battery charger 364, voltage regulator 366, head mounted display power source 376, and temperature sensor interface 372 in communication with temperature sensor 374 (possibly located on the wrist band of processing unit 4). Analog to digital converter 362 is used to monitor the battery voltage, the temperature sensor and control the battery charging function. Voltage regulator 366 is in communication with battery 368 for supplying power to the system. Battery charger 364 is used to charge battery 368 (via voltage regulator 366) upon receiving power from charging jack 370. HMD power source 376 provides power to the head mounted display device 2.

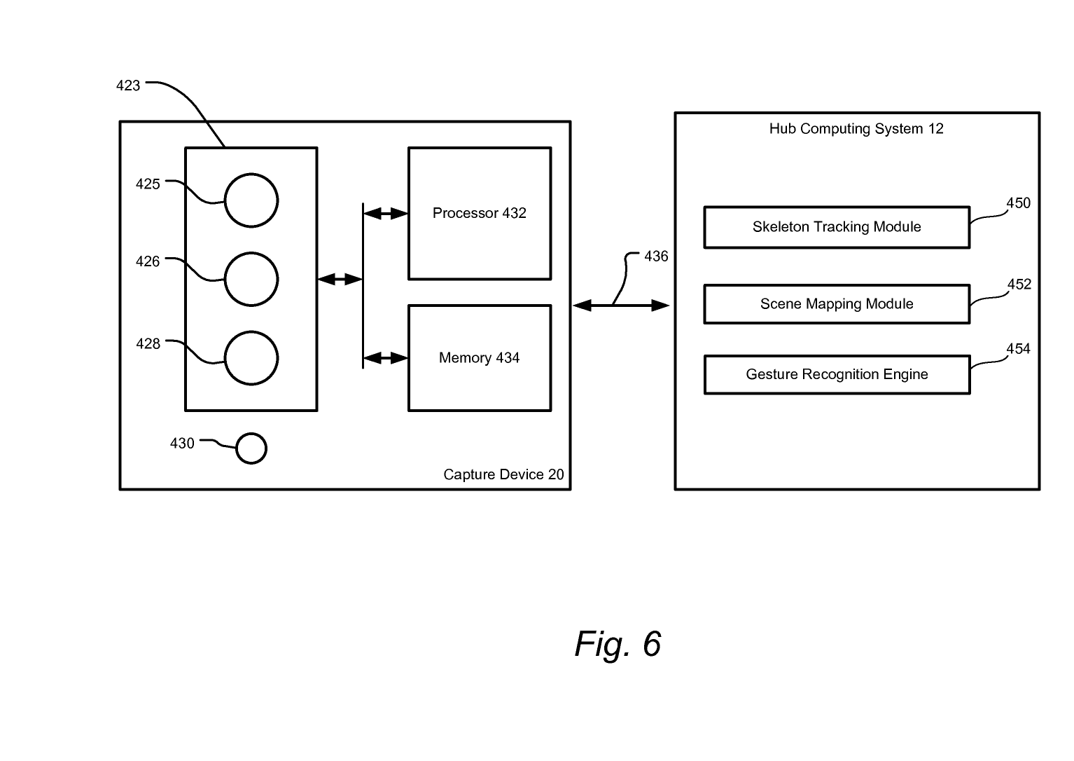

FIG. 6 illustrates an example embodiment of hub computing system 12 with a capture device 20. According to an example embodiment, capture device 20 may be configured to capture video with depth information including a depth image that may include depth values via any suitable technique including, for example, time-of-flight, structured light, stereo image, or the like. According to one embodiment, the capture device 20 may organize the depth information into “Z layers,” or layers that may be perpendicular to a Z axis extending from the depth camera along its line of sight.

As shown in FIG. 6, capture device 20 may include a camera component 423. According to an example embodiment, camera component 423 may be or may include a depth camera that may capture a depth image of a scene. The depth image may include a two-dimensional (2-D) pixel area of the captured scene where each pixel in the 2-D pixel area may represent a depth value such as a distance in, for example, centimeters, millimeters, or the like of an object in the captured scene from the camera.

Camera component 423 may include an infra-red (IR) light component 425, a three-dimensional (3-D) camera 426, and an RGB (visual image) camera 428 that may be used to capture the depth image of a scene. For example, in time-of-flight analysis, the IR light component 425 of the capture device 20 may emit an infrared light onto the scene and may then use sensors (in some embodiments, including sensors not shown) to detect the backscattered light from the surface of one or more targets and objects in the scene using, for example, the 3-D camera 426 and/or the RGB camera 428. In some embodiments, pulsed infrared light may be used such that the time between an outgoing light pulse and a corresponding incoming light pulse may be measured and used to determine a physical distance from the capture device 20 to a particular location on the targets or objects in the scene. Additionally, in other example embodiments, the phase of the outgoing light wave may be compared to the phase of the incoming light wave to determine a phase shift. The phase shift may then be used to determine a physical distance from the capture device to a particular location on the targets or objects.

According to another example embodiment, time-of-flight analysis may be used to indirectly determine a physical distance from the capture device 20 to a particular location on the targets or objects by analyzing the intensity of the reflected beam of light over time via various techniques including, for example, shuttered light pulse imaging.

In another example embodiment, capture device 20 may use a structured light to capture depth information. In such an analysis, patterned light (i.e., light displayed as a known pattern such as a grid pattern, a stripe pattern, or different pattern) may be projected onto the scene via, for example, the IR light component 425. Upon striking the surface of one or more targets or objects in the scene, the pattern may become deformed in response. Such a deformation of the pattern may be captured by, for example, the 3-D camera 426 and/or the RGB camera 428 (and/or other sensor) and may then be analyzed to determine a physical distance from the capture device to a particular location on the targets or objects. In some implementations, the IR light component 425 is displaced from the cameras 426 and 428 so triangulation can be used to determined distance from cameras 426 and 428. In some implementations, the capture device 20 will include a dedicated IR sensor to sense the IR light, or a sensor with an IR filter.

According to another embodiment, one or more capture devices 20 may include two or more physically separated cameras that may view a scene from different angles to obtain visual stereo data that may be resolved to generate depth information. Other types of depth image sensors can also be used to create a depth image.

The capture device 20 may further include a microphone 430, which includes a transducer or sensor that may receive and convert sound into an electrical signal. Microphone 430 may be used to receive audio signals that may also be provided to hub computing system 12.

In an example embodiment, the capture device 20 may further include a processor 432 that may be in communication with the camera component 423. Processor 432 may include a standardized processor, a specialized processor, a microprocessor, or the like that may execute instructions including, for example, instructions for receiving a depth image, generating the appropriate data format (e.g., frame) and transmitting the data to hub computing system 12.

Capture device 20 may further include a memory 434 that may store the instructions that are executed by processor 432, images or frames of images captured by the 3-D camera and/or RGB camera, or any other suitable information, images, or the like. According to an example embodiment, memory 434 may include random access memory (RAM), read only memory (ROM), cache, flash memory, a hard disk, or any other suitable storage component. As shown in FIG. 6, in one embodiment, memory 434 may be a separate component in communication with the camera component 423 and processor 432. According to another embodiment, the memory 434 may be integrated into processor 432 and/or the camera component 423.

Capture device 20 is in communication with hub computing system 12 via a communication link 436. The communication link 436 may be a wired connection including, for example, a USB connection, a Firewire connection, an Ethernet cable connection, or the like and/or a wireless connection such as a wireless 802.11b, g, a, or n connection. According to one embodiment, hub computing system 12 may provide a clock to capture device 20 that may be used to determine when to capture, for example, a scene via the communication link 436. Additionally, the capture device 20 provides the depth information and visual (e.g., RGB) images captured by, for example, the 3-D camera 426 and/or the RGB camera 428 to hub computing system 12 via the communication link 436. In one embodiment, the depth images and visual images are transmitted at 30 frames per second; however, other frame rates can be used. Hub computing system 12 may then create and use a model, depth information, and captured images to, for example, control an application such as a game or word processor and/or animate an avatar or on-screen character.

Hub computing system 12 includes a skeletal tracking module 450. Module 450 uses the depth images obtained in each frame from capture device 20, and possibly from cameras on the one or more head mounted display devices 2, to develop a representative model of each user 18a, 18b, 18c (or others) within the FOV of capture device 20 as each user moves around in the scene. This representative model may be a skeletal model described below. Hub computing system 12 may further include a scene mapping module 452. Scene mapping module 452 uses depth and possibly RGB image data obtained from capture device 20, and possibly from cameras on the one or more head mounted display devices 2, to develop a map or model of the scene in which the users 18a, 18b, 18c exist. The scene map may further include the positions of the users obtained from the skeletal tracking module 450. The hub computing system may further include a gesture recognition engine 454 for receiving skeletal model data for one or more users in the scene and determining whether the user is performing a predefined gesture or application-control movement affecting an application running on hub computing system 12.

The skeletal tracking module 450 and scene mapping module 452 are explained in greater detail below. More information about gesture recognition engine 454 can be found in U.S. patent application Ser. No. 12/422,661, entitled “Gesture Recognizer System Architecture,” filed on Apr. 13, 2009, incorporated herein by reference in its entirety. Additional information about recognizing gestures can also be found in U.S. patent application Ser. No. 12/391,150, entitled “Standard Gestures,” filed on Feb. 23, 2009; and U.S. patent application Ser. No. 12/474,655, entitled “Gesture Tool” filed on May 29, 2009, both of which are incorporated herein by reference in their entirety.

Capture device 20 provides RGB images (or visual images in other formats or color spaces) and depth images to hub computing system 12. The depth image may be a plurality of observed pixels where each observed pixel has an observed depth value. For example, the depth image may include a two-dimensional (2-D) pixel area of the captured scene where each pixel in the 2-D pixel area may have a depth value such as the distance of an object in the captured scene from the capture device. Hub computing system 12 will use the RGB images and depth images to develop a skeletal model of a user and to track a user's or other object's movements. There are many methods that can be used to model and track the skeleton of a person with depth images. One suitable example of tracking a skeleton using depth image is provided in U.S. patent application Ser. No. 12/603,437, entitled “Pose Tracking Pipeline” filed on Oct. 21, 2009, (hereinafter referred to as the '437 application), incorporated herein by reference in its entirety.

The process of the '437 application includes acquiring a depth image, down sampling the data, removing and/or smoothing high variance noisy data, identifying and removing the background, and assigning each of the foreground pixels to different parts of the body. Based on those steps, the system will fit a model to the data and create a skeleton. The skeleton will include a set of joints and connections between the joints. Other methods for user modeling and tracking can also be used. Suitable tracking technologies are also disclosed in the following four U.S. patent applications, all of which are incorporated herein by reference in their entirety: U.S. patent application Ser. No. 12/475,308, entitled “Device for Identifying and Tracking Multiple Humans Over Time,” filed on May 29, 2009; U.S. patent application Ser. No. 12/696,282, entitled “Visual Based Identity Tracking,” filed on Jan. 29, 2010; U.S. patent application Ser. No. 12/641,788, entitled “Motion Detection Using Depth Images,” filed on Dec. 18, 2009; and U.S. patent application Ser. No. 12/575,388, entitled “Human Tracking System,” filed on Oct. 7, 2009.

The above-described hub computing system 12, together with the head mounted display device 2 and processing unit 4, are able to insert a virtual three-dimensional object into the FOV of one or more users so that the virtual three-dimensional object augments and/or replaces the view of the real world. In one embodiment, head mounted display device 2, processing unit 4 and hub computing system 12 work together as each of the devices includes a subset of sensors that are used to obtain the data to determine where, when and how to insert the virtual three-dimensional object. In one embodiment, the calculations that determine where, when and how to insert a virtual three-dimensional object are performed by the hub computing system 12 and processing unit 4 working in tandem with each other. However, in further embodiments, all calculations may be performed by the hub computing system 12 working alone or the processing unit(s) 4 working alone. In other embodiments, at least some of the calculations can be performed by a head mounted display device 2.

In one example embodiment, hub computing system 12 and processing units 4 work together to create the scene map or model of the environment that the one or more users are in and track various moving objects in that environment. In addition, hub computing system 12 and/or processing unit 4 track the FOV of a head mounted display device 2 worn by a user 18a, 18b, 18c by tracking the position and orientation of the head mounted display device 2. Sensor information obtained by head mounted display device 2 is transmitted to processing unit 4. In one example, that information is transmitted to the hub computing system 12 which updates the scene model and transmits it back to the processing unit. The processing unit 4 then uses additional sensor information it receives from head mounted display device 2 to refine the FOV of the user and provide instructions to head mounted display device 2 on where, when and how to insert the virtual three-dimensional object. Based on sensor information from cameras in the capture device 20 and head mounted display device(s) 2, the scene model and the tracking information may be periodically updated between hub computing system 12 and processing unit 4 in a closed loop feedback system as explained below.

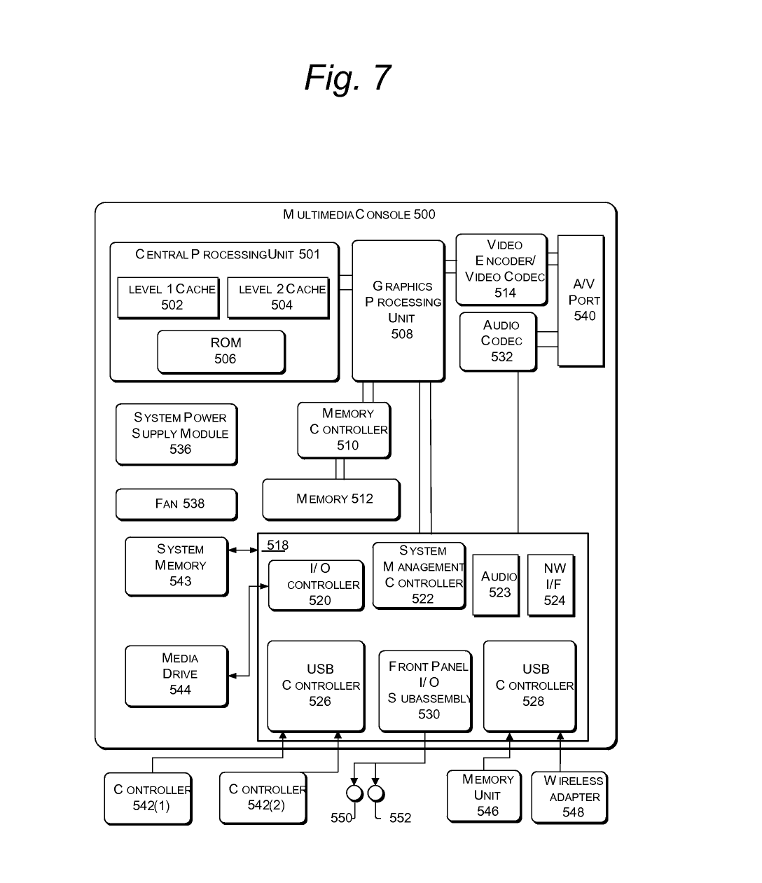

FIG. 7 illustrates an example embodiment of a computing system that may be used to implement hub computing system 12. As shown in FIG. 7, the multimedia console 500 has a central processing unit (CPU) 501 having a level 1 cache 502, a level 2 cache 504, and a flash ROM (Read Only Memory) 506. The level 1 cache 502 and a level 2 cache 504 temporarily store data and hence reduce the number of memory access cycles, thereby improving processing speed and throughput. CPU 501 may be provided having more than one core, and thus, additional level 1 and level 2 caches 502 and 504. The flash ROM 506 may store executable code that is loaded during an initial phase of a boot process when the multimedia console 500 is powered on.

A graphics processing unit (GPU) 508 and a video encoder/video codec (coder/decoder) 514 form a video processing pipeline for high speed and high resolution graphics processing. Data is carried from the graphics processing unit 508 to the video encoder/video codec 514 via a bus. The video processing pipeline outputs data to an A/V (audio/video) port 540 for transmission to a television or other display. A memory controller 510 is connected to the GPU 508 to facilitate processor access to various types of memory 512, such as, but not limited to, a RAM (Random Access Memory).

The multimedia console 500 includes an I/O controller 520, a system management controller 522, an audio processing unit 523, a network interface 524, a first USB host controller 526, a second USB controller 528 and a front panel I/O subassembly 530 that are preferably implemented on a module 518. The USB controllers 526 and 528 serve as hosts for peripheral controllers 542(1)-542(2), a wireless adapter 548, and an external memory device 546 (e.g., flash memory, external CD/DVD ROM drive, removable media, etc.). The network interface 524 and/or wireless adapter 548 provide access to a network (e.g., the Internet, home network, etc.) and may be any of a wide variety of various wired or wireless adapter components including an Ethernet card, a modem, a Bluetooth module, a cable modem, and the like.

System memory 543 is provided to store application data that is loaded during the boot process. A media drive 544 is provided and may comprise a DVD/CD drive, Blu-Ray drive, hard disk drive, or other removable media drive, etc. The media drive 544 may be internal or external to the multimedia console 500. Application data may be accessed via the media drive 544 for execution, playback, etc. by the multimedia console 500. The media drive 544 is connected to the I/O controller 520 via a bus, such as a Serial ATA bus or other high speed connection (e.g., IEEE 1394).

The system management controller 522 provides a variety of service functions related to assuring availability of the multimedia console 500. The audio processing unit 523 and an audio codec 532 form a corresponding audio processing pipeline with high fidelity and stereo processing. Audio data is carried between the audio processing unit 523 and the audio codec 532 via a communication link. The audio processing pipeline outputs data to the A/V port 540 for reproduction by an external audio user or device having audio capabilities.

The front panel I/O subassembly 530 supports the functionality of the power button 550 and the eject button 552, as well as any LEDs (light emitting diodes) or other indicators exposed on the outer surface of the multimedia console 500. A system power supply module 536 provides power to the components of the multimedia console 500. A fan 538 cools the circuitry within the multimedia console 500.

The CPU 501, GPU 508, memory controller 510, and various other components within the multimedia console 500 are interconnected via one or more buses, including serial and parallel buses, a memory bus, a peripheral bus, and a processor or local bus using any of a variety of bus architectures. By way of example, such architectures can include a Peripheral Component Interconnects (PCI) bus, PCI-Express bus, etc.

When the multimedia console 500 is powered on, application data may be loaded from the system memory 543 into memory 512 and/or caches 502, 504 and executed on the CPU 501. The application may present a graphical user interface that provides a consistent user experience when navigating to different media types available on the multimedia console 500. In operation, applications and/or other media contained within the media drive 544 may be launched or played from the media drive 544 to provide additional functionalities to the multimedia console 500.

The multimedia console 500 may be operated as a standalone system by simply connecting the system to a television or other display. In this standalone mode, the multimedia console 500 allows one or more users to interact with the system, watch movies, or listen to music. However, with the integration of broadband connectivity made available through the network interface 524 or the wireless adapter 548, the multimedia console 500 may further be operated as a participant in a larger network community. Additionally, multimedia console 500 can communicate with processing unit 4 via wireless adaptor 548.

When the multimedia console 500 is powered ON, a set amount of hardware resources are reserved for system use by the multimedia console operating system. These resources may include a reservation of memory, CPU and GPU cycle, networking bandwidth, etc. Because these resources are reserved at system boot time, the reserved resources do not exist from the application's view. In particular, the memory reservation preferably is large enough to contain the launch kernel, concurrent system applications and drivers. The CPU reservation is preferably constant such that if the reserved CPU usage is not used by the system applications, an idle thread will consume any unused cycles.

With regard to the GPU reservation, lightweight messages generated by the system applications (e.g., pop ups) are displayed by using a GPU interrupt to schedule code to render popup into an overlay. The amount of memory used for an overlay depends on the overlay area size and the overlay preferably scales with screen resolution. Where a full user interface is used by the concurrent system application, it is preferable to use a resolution independent of application resolution. A scaler may be used to set this resolution such that changing frequency and causing a TV resync may be reduced or eliminated.

After multimedia console 500 boots and system resources are reserved, concurrent system applications execute to provide system functionalities. The system functionalities are encapsulated in a set of system applications that execute within the reserved system resources described above. The operating system kernel identifies threads that are system application threads versus gaming application threads. The system applications are preferably scheduled to run on the CPU 501 at predetermined times and intervals in order to provide a consistent system resource view to the application. The scheduling is to minimize cache disruption for the gaming application running on the console.

When a concurrent system application requires audio, audio processing is scheduled asynchronously to the gaming application due to time sensitivity. A multimedia console application manager (described below) controls the gaming application audio level (e.g., mute, attenuate) when system applications are active.

Optional input devices (e.g., controllers 542(1) and 542(2)) are shared by gaming applications and system applications. The input devices are not reserved resources, but are to be switched between system applications and the gaming application such that each will have a focus of the device. The application manager preferably controls the switching of input stream, without knowing the gaming application's knowledge and a driver maintains state information regarding focus switches. Capture device 20 may define additional input devices for the console 500 via USB controller 526 or other interface. In other embodiments, hub computing system 12 can be implemented using other hardware architectures.

Each of the head mounted display devices 2 and processing units 4 (collectively referred to at times as the mobile display device) shown in FIG. 1 are in communication with one hub computing system 12 (also referred to as the hub 12). There may be one or two or more mobile display devices in communication with the hub 12 in further embodiments. Each of the mobile display devices may communicate with the hub using wireless communication, as described above. In such an embodiment, it is contemplated that much of the information that is useful to the mobile display devices will be computed and stored at the hub and transmitted to each of the mobile display devices. For example, the hub will generate the model of the environment and provide that model to all of the mobile display devices in communication with the hub. Additionally, the hub can track the location and orientation of the mobile display devices and of the moving objects in the room, and then transfer that information to each of the mobile display devices.

In another embodiment, a system could include multiple hubs 12, with each hub including one or more mobile display devices. The hubs can communicate with each other directly or via the Internet (or other networks). Such an embodiment is disclosed in U.S. patent application Ser. No. 12/905,952 to Flaks et al., entitled “Fusing Virtual Content Into Real Content,” filed Oct. 15, 2010, which application is incorporated by reference herein in its entirety.

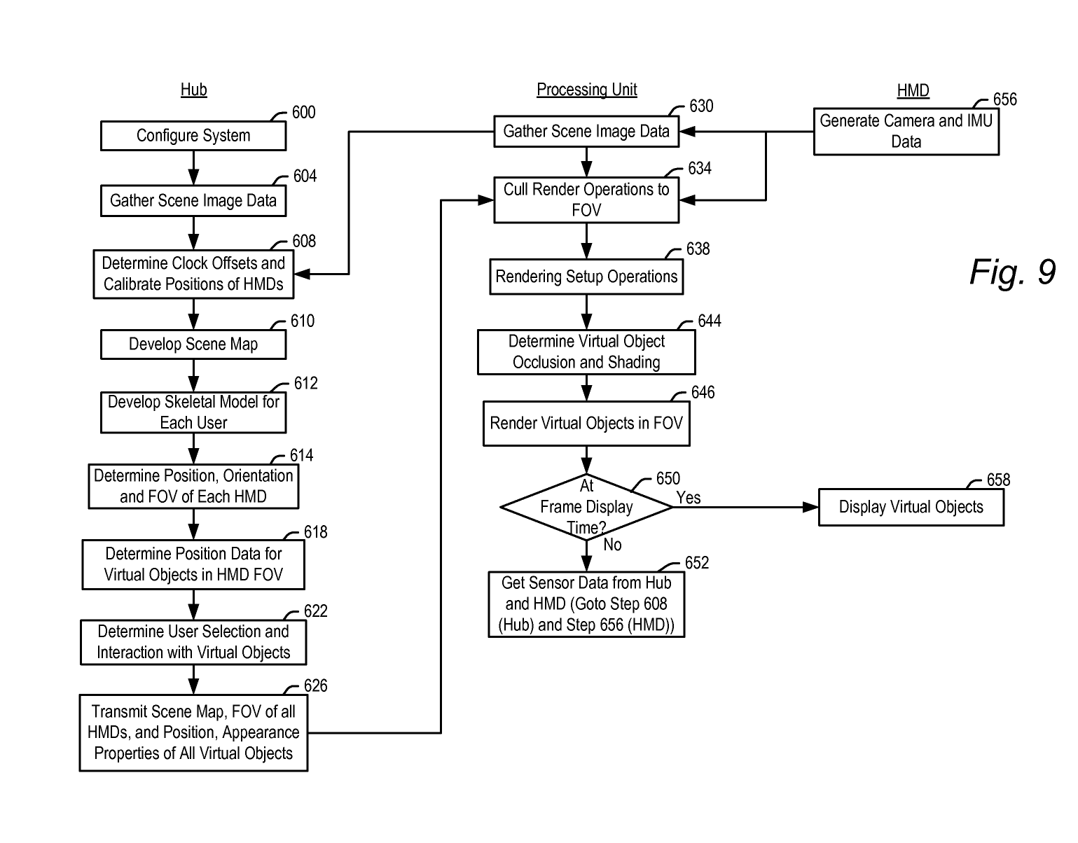

Moreover, in further embodiments, the hub 12 may be omitted altogether. One benefit of such an embodiment is that the mixed reality experience of the present system becomes completely mobile, and may be used in both indoor or outdoor settings. In such an embodiment, all functions performed by the hub 12 in the description that follows may alternatively be performed by one of the processing units 4, some of the processing units 4 working in tandem, or all of the processing units 4 working in tandem. In such an embodiment, the respective mobile display devices 580 perform all functions of system 10, including generating and updating state data, a scene map, each user's view of the scene map, all texture and rendering information, video and audio data, and other information to perform the operations described herein. The embodiments described below with respect to the flowchart of FIG. 9 include a hub 12. However, in each such embodiment, one or more of the processing units 4 may alternatively perform all described functions of the hub 12.

Using the components described above, virtual objects may be displayed to a user 18 via head mounted display device 2. Some virtual objects are intended to remain stationary and/or not interactive within a scene. These virtual objects are referred to herein as “static virtual objects.” Other virtual objects are intended to move, or be movable, within a scene, and can be interacted with. These virtual objects are referred to as “dynamic virtual objects.”

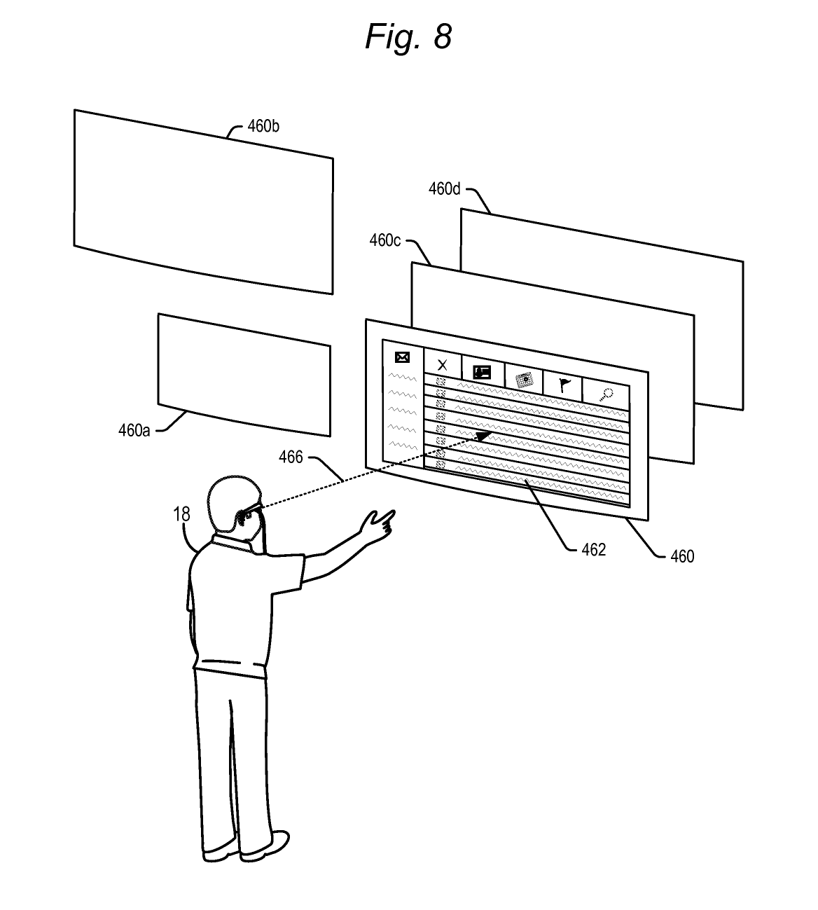

An example of a dynamic virtual object is the one or more virtual display slates 460 shown in FIG. 8. A virtual display slate 460 is a virtual screen displayed to the user on which content 462 is presented to the user. The opacity filter 114 is used to mask real world objects and light behind (from the user's view point) the virtual display slate 460, so that the virtual display slate 460 appears as a virtual screen for viewing selected content 462. A virtual display slate 460 may be displayed to a user in a variety of forms, but in embodiments, the slate may have a front where content is displayed, top, bottom and side edges where a user would see the thickness of the virtual display if the user's viewing angle was aligned with (parallel to) a plane in which the display is positioned, and a back which is blank. In embodiments, the back may display a mirror image of what is displayed on the front. This is analogous to displaying a movie on a movie screen. Viewers can see the image on the front of the screen, and the mirror image on the back of the screen.

The content 462 may be a wide variety of content, including static content such as text and graphics, or dynamic content such as video. A virtual display slate 460 may further act as a computer monitor, so that the content 462 may be email, web pages, games or any other content presented on a monitor. In the example shown, content 462 is a user interface from an email software application. It is understood that this illustration is by way of example, and the content 462 can be any of a variety of user interfaces, graphics and/or videos. A software application running on hub 12 may generate the virtual display slate 460, as well as determine the content 462 to be displayed on virtual display slate 460. In embodiments explained below, the position and size of virtual display slate 460, as well as the type of content 462 displayed on virtual display slate 460, may be user configurable through gestures and the like.

It is also understood that more than one virtual display slate 460 may be presented to the user, such as virtual display slates 460a, 460b, 460c and 460d in FIG. 8. Virtual display slates 460a-460d may be positioned as desired by the user, and may present any content desired by the user. The slates may be positioned to the sides of each other (virtual display slates 460, 460a), above and below each other (virtual display slates 460a, 460b), and possibly overlapping each other (virtual display slates 460, 460c, 460d). While five virtual display slates 460 are shown in FIG. 8, more or less than five virtual display slates may be presented in further embodiments, arranged as desired by the user 18. A user may select a given dynamic virtual object such as virtual display slate 460 as explained below. Thereafter, the user may interact with the content on the selected slate, and/or move, resize or close the selected slate.

FIG. 9 is high level flowchart of the operation and interactivity of the hub computing system 12, the processing unit 4 and head mounted display device 2 during a discrete time period such as the time it takes to generate, render and display a single frame of image data to each user. In embodiments, data may be refreshed at a rate of 60 Hz, though it may be refreshed more often or less often in further embodiments.

In general, the system generates a scene map having x, y, z coordinates of the environment and objects in the environment such as users, real world objects and virtual objects. As noted above, the virtual object such as virtual display slate 460 may be virtually placed in the environment for example by an application running on hub computing system 12. The system also tracks the FOV of each user. While all users may possibly be viewing the same aspects of the scene, they are viewing them from different perspectives. Thus, the system generates each person's FOV of the scene to adjust for parallax and occlusion of virtual or real world objects, which may again be different for each user.

For a given frame of image data, a user's view may include one or more real and/or virtual objects. As a user turns his head, for example left to right or up and down, the relative position of real world objects in the user's FOV inherently moves within the user's FOV. For example, plant 27 in FIG. 1 may appear on the right side of a user's FOV at first. But if the user then turns his head toward the right, the plant 27 may eventually end up on the left side of the user's FOV.

However, the display of virtual objects to a user as the user moves his head is a more difficult problem. In an example where a user is looking at a static virtual object in his FOV, if the user moves his head left to move the FOV left, the display of the static virtual object may be shifted to the right by an amount of the user's FOV shift, so that the net effect is that the static virtual object remains stationary within the FOV. A system for properly displaying static and dynamic virtual objects is explained below with respect to the flowchart of FIGS. 9-16A.

The system for presenting mixed reality to one or more users 18 may be configured in step 600. For example, a user 18 or operator of the system may specify the virtual objects that are to be presented, whether they are to be static or dynamic virtual objects, and how, when and where they are to be presented. In an alternative embodiment, an application running on hub 12 and/or processing unit 4 can configure the system as to the static and/or dynamic virtual objects that are to be presented.

In one example, the application may select one or more static and/or dynamic virtual objects for presentation in default locations within the scene. Alternatively or additionally, the user may select one or more predefined static and/or dynamic virtual objects for inclusion in the scene. Whether selected by the application or user, the user may thereafter have the option to change the default position of one or more of the dynamic virtual objects. For example, the user may select a virtual display slate 460 for positioning at the center or near center of his FOV. Alternatively, a user may send a virtual display slate 460 onto a wall. These options may for example be carried out by the user performing grabbing and moving gestures with his hands, though it may be carried out in other ways in further embodiments.

In steps 604 and 630, hub 12 and processing unit 4 gather data from the scene. For the hub 12, this may be image and audio data sensed by the depth camera 426, RGB camera 428 and microphone 430 of capture device 20. For the processing unit 4, this may be image data sensed in step 656 by the head mounted display device 2, and in particular, by the cameras 112, the eye tracking assemblies 134 and the IMU 132. The data gathered by the head mounted display device 2 is sent to the processing unit 4 in step 656. The processing unit 4 processes this data, as well as sending it to the hub 12 in step 630.

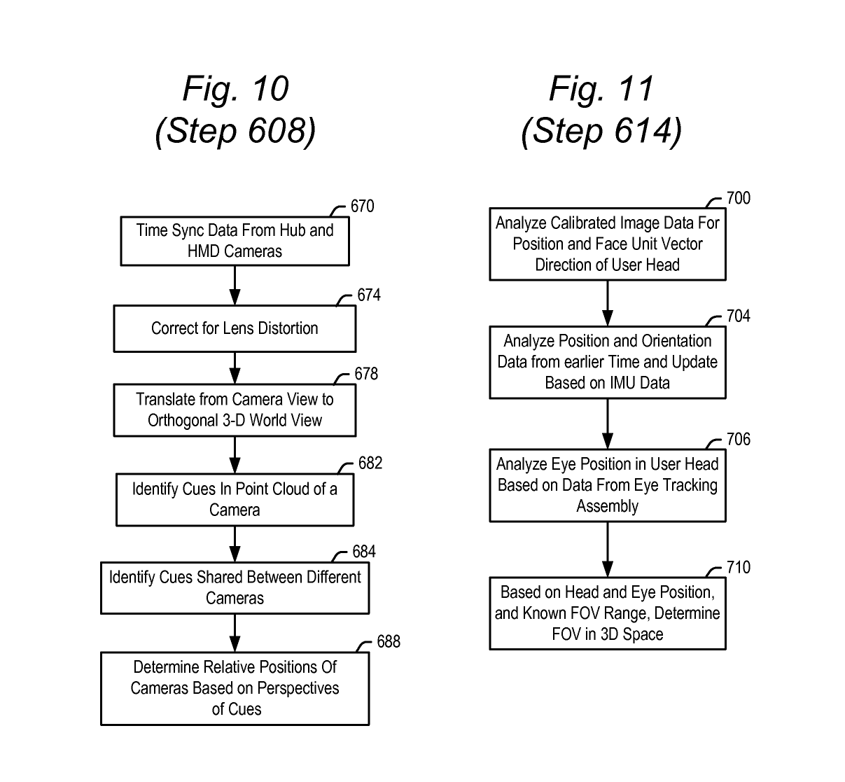

In step 608, the hub 12 performs various setup operations that allow the hub 12 to coordinate the image data of its capture device 20 and the one or more processing units 4. In particular, even if the position of the capture device 20 is known with respect to a scene (which it may not be), the cameras on the head mounted display devices 2 are moving around in the scene. Therefore, in embodiments, the positions and time capture of each of the imaging cameras may be calibrated to the scene, each other and the hub 12. Further details of step 608 are now described with reference to the flowchart of FIG. 10.

One operation of step 608 includes determining clock offsets of the various imaging devices in the system 10 in a step 670. In particular, in order to coordinate the image data from each of the cameras in the system, it may be confirmed that the image data being coordinated is from the same time. Details relating to determining clock offsets and synching of image data are disclosed in U.S. patent application Ser. No. 12/772,802, entitled “Heterogeneous Image Sensor Synchronization,” filed May 3, 2010, and U.S. patent application Ser. No. 12/792,961, entitled “Synthesis Of Information From Multiple Audiovisual Sources,” filed Jun. 3, 2010, which applications are incorporated herein by reference in their entirety. In general, the image data from capture device 20 and the image data coming in from the one or more processing units 4 are time stamped off a single master clock in hub 12. Using the time stamps for all such data for a given frame, as well as the known resolution for each of the cameras, the hub 12 determines the time offsets for each of the imaging cameras in the system. From this, the hub 12 may determine the differences between, and an adjustment to, the images received from each camera.

The hub 12 may select a reference time stamp from one of the cameras' received frame. The hub 12 may then add time to or subtract time from the received image data from all other cameras to synch to the reference time stamp. It is appreciated that a variety of other operations may be used for determining time offsets and/or synchronizing the different cameras together for the calibration process. The determination of time offsets may be performed once, upon initial receipt of image data from all the cameras. Alternatively, it may be performed periodically, such as for example each frame or some number of frames.

Step 608 further includes the operation of calibrating the positions of all cameras with respect to each other in the x, y, z Cartesian space of the scene. Once this information is known, the hub 12 and/or the one or more processing units 4 is able to form a scene map or model identify the geometry of the scene and the geometry and positions of objects (including users) within the scene. In calibrating the image data of all cameras to each other, depth and/or RGB data may be used. Technology for calibrating camera views using RGB information alone is described for example in U.S. Patent Publication No. 2007/0110338, entitled “Navigating Images Using Image Based Geometric Alignment and Object Based Controls,” published May 17, 2007, which publication is incorporated herein by reference in its entirety.

The imaging cameras in system 10 may each have some lens distortion which may be corrected for in order to calibrate the images from different cameras. Once all image data from the various cameras in the system is received in steps 604 and 630, the image data may be adjusted to account for lens distortion for the various cameras in step 674. The distortion of a given camera (depth or RGB) may be a known property provided by the camera manufacturer. If not, algorithms are known for calculating a camera's distortion, including for example imaging an object of known dimensions such as a checker board pattern at different locations within a camera's FOV. The deviations in the camera view coordinates of points in that image will be the result of camera lens distortion. Once the degree of lens distortion is known, distortion may be corrected by known inverse matrix transformations that result in a uniform camera view map of points in a point cloud for a given camera.

The hub 12 may next translate the distortion-corrected image data points captured by each camera from the camera view to an orthogonal 3-D world view in step 678. This orthogonal 3-D world view is a point cloud map of all image data captured by capture device 20 and the head mounted display device cameras in an orthogonal x, y, z Cartesian coordinate system. The matrix transformation equations for translating camera view to an orthogonal 3-D world view are known. See, for example, David H. Eberly, “3d Game Engine Design: A Practical Approach To Real-Time Computer Graphics,” Morgan Kaufman Publishers (2000), which publication is incorporated herein by reference in its entirety. See also, U.S. patent application Ser. No. 12/792,961, previously incorporated by reference.

Each camera in system 10 may construct an orthogonal 3-D world view in step 678. The x, y, z world coordinates of data points from a given camera are still from the perspective of that camera at the conclusion of step 678, and not yet correlated to the x, y, z world coordinates of data points from other cameras in the system 10. The next step is to translate the various orthogonal 3-D world views of the different cameras into a single overall 3-D world view shared by all cameras in system 10.

To accomplish this, embodiments of the hub 12 may next look for key-point discontinuities, or cues, in the point clouds of the world views of the respective cameras in step 682, and then identifies cues that are the same between different point clouds of different cameras in step 684. Once the hub 12 is able to determine that two world views of two different cameras include the same cues, the hub 12 is able to determine the position, orientation and focal length of the two cameras with respect to each other and the cues in step 688. In embodiments, not all cameras in system 10 will share the same common cues. However, as long as a first and second camera have shared cues, and at least one of those cameras has a shared view with a third camera, the hub 12 is able to determine the positions, orientations and focal lengths of the first, second and third cameras relative to each other and a single, overall 3-D world view. The same is true for additional cameras in the system.

Various known algorithms exist for identifying cues from an image point cloud. Such algorithms are set forth for example in Mikolajczyk, K., and Schmid, C., “A Performance Evaluation of Local Descriptors,” IEEE Transactions on Pattern Analysis & Machine Intelligence, 27, 10, 1615-1630. (2005), which paper is incorporated by reference herein in its entirety. A further method of detecting cues with image data is the Scale-Invariant Feature Transform (SIFT) algorithm. The SIFT algorithm is described for example in U.S. Pat. No. 6,711,293, entitled, “Method and Apparatus for Identifying Scale Invariant Features in an Image and Use of Same for Locating an Object in an Image,” issued Mar. 23, 2004, which patent is incorporated by reference herein in its entirety. Another cue detector method is the Maximally Stable Extremal Regions (MSER) algorithm. The MSER algorithm is described for example in the paper by J. Matas, O. Chum, M. Urba, and T. Pajdla, “Robust Wide Baseline Stereo From Maximally Stable Extremal Regions,” Proc. of British Machine Vision Conference, pages 384-396 (2002), which paper is incorporated by reference herein in its entirety.

In step 684, cues which are shared between point clouds from two or more cameras are identified. Conceptually, where a first set of vectors exist between a first camera and a set of cues in the first camera's Cartesian coordinate system, and a second set of vectors exist between a second camera and that same set of cues in the second camera's Cartesian coordinate system, the two systems may be resolved with respect to each other into a single Cartesian coordinate system including both cameras. A number of known techniques exist for finding shared cues between point clouds from two or more cameras. Such techniques are shown for example in Arya, S., Mount, D. M., Netanyahu, N. S., Silverman, R., and Wu, A. Y., “An Optimal Algorithm For Approximate Nearest Neighbor Searching Fixed Dimensions,” Journal of the ACM 45, 6, 891-923 (1998), which paper is incorporated by reference herein in its entirety. Other techniques can be used instead of, or in addition to, the approximate nearest neighbor solution of Arya et al., incorporated above, including but not limited to hashing or context-sensitive hashing.

Where the point clouds from two different cameras share a large enough number of matched cues, a matrix correlating the two point clouds together may be estimated, for example by Random Sampling Consensus (RANSAC), or a variety of other estimation techniques. Matches that are outliers to the recovered fundamental matrix may then be removed. After finding a set of assumed, geometrically consistent matches between a pair of point clouds, the matches may be organized into a set of tracks for the respective point clouds, where a track is a set of mutually matching cues between point clouds. A first track in the set may contain a projection of each common cue in the first point cloud. A second track in the set may contain a projection of each common cue in the second point cloud. The point clouds from different cameras may be resolved into a single point cloud in a single orthogonal 3-D real world view.

The positions and orientations of the cameras are calibrated with respect to this single point cloud and single orthogonal 3-D real world view. In order to resolve the various point clouds together, the projections of the cues in the set of tracks for two point clouds are analyzed. From these projections, the hub 12 can determine the perspective of a first camera with respect to the cues, and can also determine the perspective of a second camera with respect to the cues. From that, the hub 12 can resolve the point clouds into an estimate of a single point cloud and single orthogonal 3-D real world view containing the cues and other data points from both point clouds.

This process is repeated for any other cameras, until the single orthogonal 3-D real world view includes all cameras. Once this is done, the hub 12 can determine the relative positions and orientations of the cameras relative to the single orthogonal 3-D real world view and each other. The hub 12 can further determine the focal length of each camera with respect to the single orthogonal 3-D real world view.

Referring again to FIG. 9, once the system is calibrated in step 608, a scene map may be developed in step 610 identifying the geometry of the scene as well as the geometry and positions of objects within the scene. In embodiments, the scene map generated in a given frame may include the x, y and z positions of all users, real world objects and virtual objects in the scene. All of this information is obtained during the image data gathering steps 604, 630 and 656 and is calibrated together in step 608.

At least the capture device 20 includes a depth camera for determining the depth of the scene (to the extent it may be bounded by walls, etc.) as well as the depth position of objects within the scene. As explained below, the scene map is used in positioning virtual objects within the scene, as well as displaying virtual three-dimensional objects with the proper occlusion (a virtual three-dimensional object may be occluded, or a virtual three-dimensional object may occlude, a real world object or another virtual three-dimensional object).

The system 10 may include multiple depth image cameras to obtain all of the depth images from a scene, or a single depth image camera, such as for example depth image camera 426 of capture device 20 may be sufficient to capture all depth images from a scene. An analogous method for determining a scene map within an unknown environment is known as simultaneous localization and mapping (SLAM). One example of SLAM is disclosed in U.S. Pat. No. 7,774,158, entitled “Systems and Methods for Landmark Generation for Visual Simultaneous Localization and Mapping,” issued Aug. 10, 2010, which patent is incorporated herein by reference in its entirety.

In step 612, the system will detect and track moving objects such as humans moving in the room, and update the scene map based on the positions of moving objects. This includes the use of skeletal models of the users within the scene as described above. In step 614, the hub determines the x, y and z position, the orientation and the FOV of each head mounted display device 2 for all users within the system 10. Further details of step 614 are now described with respect to the flowchart of FIG. 11. The steps of FIG. 11 are described below with respect to a single user. However, the steps of FIG. 11 would be carried out for each user within the scene.

In step 700, the calibrated image data for the scene is analyzed at the hub to determine both the user head position and a face unit vector looking straight out from a user's face. The head position is identified in the skeletal model. The face unit vector may be determined by defining a plane of the user's face from the skeletal model, and taking a vector perpendicular to that plane. This plane may be identified by determining a position of a user's eyes, nose, mouth, ears or other facial features. The face unit vector may be used to define the user's head orientation and, in examples, may be considered the center of the FOV for the user. The face unit vector may also or alternatively be identified from the camera image data returned from the cameras 112 on head mounted display device 2. In particular, based on what the cameras 112 on head mounted display device 2 see, the associated processing unit 4 and/or hub 12 is able to determine the face unit vector representing a user's head orientation.

In step 704, the position and orientation of a user's head may also or alternatively be determined from analysis of the position and orientation of the user's head from an earlier time (either earlier in the frame or from a prior frame), and then using the inertial information from the IMU 132 to update the position and orientation of a user's head. Information from the IMU 132 may provide accurate kinematic data for a user's head, but the IMU typically does not provide absolute position information regarding a user's head. This absolute position information, also referred to as “ground truth,” may be provided from the image data obtained from capture device 20, the cameras on the head mounted display device 2 for the subject user and/or from the head mounted display device(s) 2 of other users.

In embodiments, the position and orientation of a user's head may be determined by steps 700 and 704 acting in tandem. In further embodiments, one or the other of steps 700 and 704 may be used to determine head position and orientation of a user's head.

It may happen that a user is not looking straight ahead. Therefore, in addition to identifying user head position and orientation, the hub may further consider the position of the user's eyes in his head. This information may be provided by the eye tracking assembly 134 described above. The eye tracking assembly is able to identify a position of the user's eyes, which can be represented as an eye unit vector showing the left, right, up and/or down deviation from a position where the user's eyes are centered and looking straight ahead (i.e., the face unit vector). A face unit vector may be adjusted to the eye unit vector to define where the user is looking.

In step 710, the FOV of the user may next be determined. The range of view of a user of a head mounted display device 2 may be predefined based on the up, down, left and right peripheral vision of a hypothetical user. In order to ensure that the FOV calculated for a given user includes objects that a particular user may be able to see at the extents of the FOV, this hypothetical user may be taken as one having a maximum possible peripheral vision. Some predetermined extra FOV may be added to this to ensure that enough data is captured for a given user in embodiments.

The FOV for the user at a given instant may then be calculated by taking the range of view and centering it around the face unit vector, adjusted by any deviation of the eye unit vector. In addition to defining what a user is looking at in a given instant, this determination of a user's FOV is also useful for determining what a user cannot see. As explained below, limiting processing of virtual objects to those areas that a particular user can see improves processing speed and reduces latency.

In the embodiment described above, the hub 12 calculates the FOV of the one or more users in the scene. In further embodiments, the processing unit 4 for a user may share in this task. For example, once user head position and eye orientation are estimated, this information may be sent to the processing unit which can update the position, orientation, etc. based on more recent data as to head position (from IMU 132) and eye position (from eye tracking assembly 134).

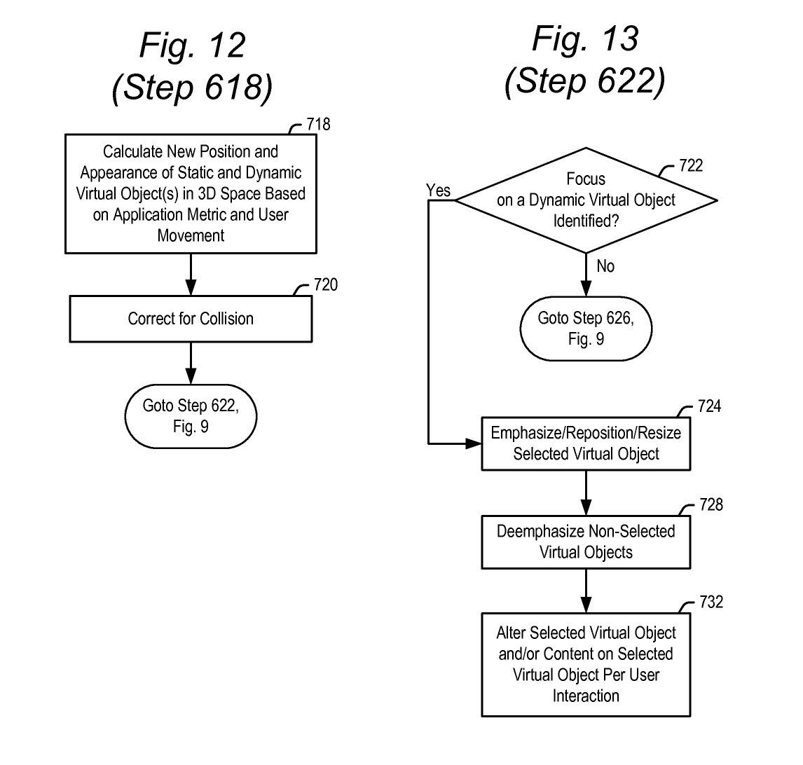

Returning now to FIG. 9, an application running on hub 12 may have placed static and/or dynamic virtual objects in the scene. In step 618, the hub 12 may use the scene map, and any user or application-defined movement of the static and dynamic virtual objects, to determine the x, y and z positions of all such static and dynamic virtual objects at the current time. Alternatively, this information may be generated by one or more of the processing units 4 and sent to the hub 12 in step 618. Details of step 618 are shown in FIG. 12.

In step 718, the hub 12 calculates a new position of the virtual three-dimensional object based on one or more application metrics. For example, the application may set whether and how fast the virtual three-dimensional object is moving in a scene. It may determine a change in shape, appearance or orientation of the virtual three-dimensional object. The application may affect a variety of other changes to a virtual object.

Moreover, a user moving within a scene may change the appearance of a virtual object. For example, if a user moves closer to a virtual object, the object may be projected larger. If a user moves around a virtual object, the virtual object is displayed from a different vantage point. This information may be determined from steps 700, 704, 706 and 710 described above for FIG. 11, where the user's FOV is determined relative to the scene map. These changes in the displayed appearance of the virtual object are provided to the hub 12, and the hub can then update the position, orientation, shape, appearance, etc. of the virtual three-dimensional object in step 718.

In step 720, the hub may check whether the updated virtual object occupies the same space as a real world object in the scene. In particular, pixel positions of real world objects in the scene are known and pixel positions of the updated virtual object are also known. If there is any overlap, the hub 12 may adjust the position of the virtual object according to default rules or metrics defined in the application.

Once the positions of both static and dynamic virtual objects are set as described in FIG. 12, the hub next determines virtual object selection and interaction in step 622 (FIG. 9). In particular, in step 622, the hub 12 determines whether a user has selected a given dynamic virtual object, such as a virtual display slate 460 of FIG. 8. The hub further determines the interaction of the user with a selected dynamic virtual object. Further details of step 622 are now described with reference to the flowchart of FIGS. 13-15.

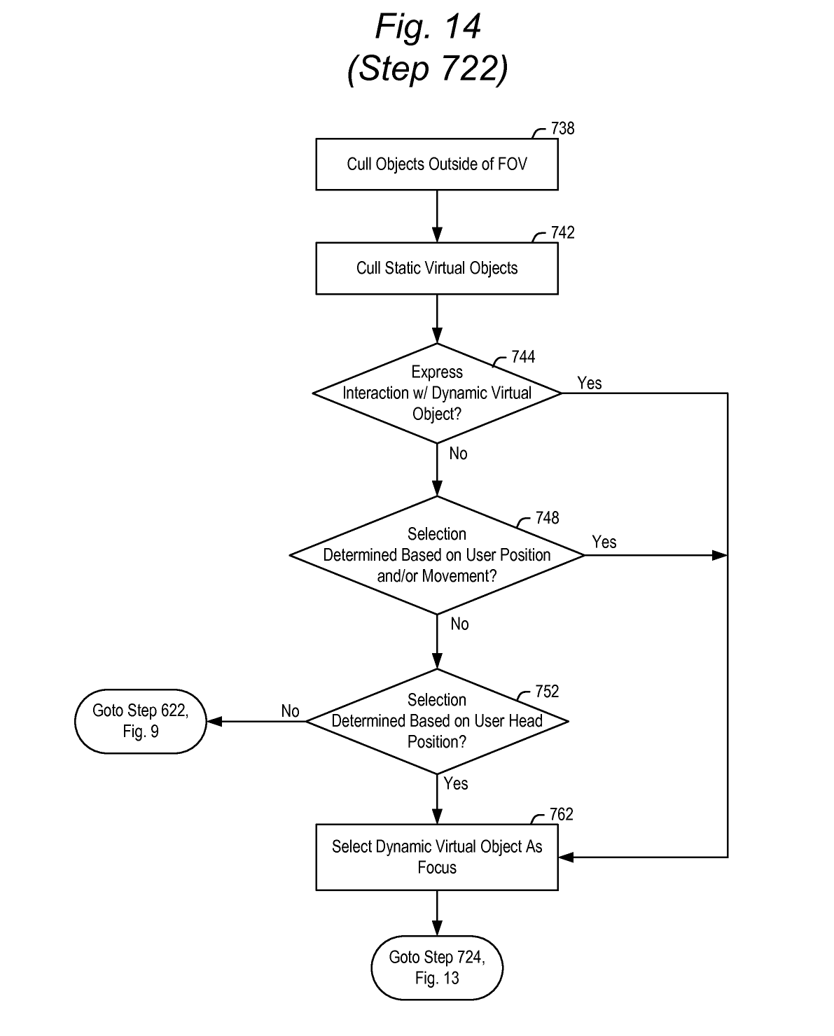

In step 722 (FIG. 13), the hub 12 determines which, if any, of the virtual objects in the scene the user is focused on. FIG. 14 provides further detail of focus step 722. The hub 12 initially culls all virtual objects that are outside of the user's FOV in step 738. Culling refers to removing virtual objects from the group of virtual objects which may be selected. If a user cannot see a virtual object, for example one that is behind him in the three-dimensional space of the scene, it is assumed that the user does not wish to select that virtual object. Similarly, in embodiments, if a virtual object is static, it may not be selected or interacted with, and is culled from consideration in step 742.

In step 744, the hub 12 looks for an express interaction with a dynamic virtual object. An express interaction may occur in at least two ways. The first is by the hub 12 detecting a predefined selection gesture performed by the user. The second is by the hub 12 detecting a predefined interaction gesture performed by the user.

A predefined selection gesture is a gesture performed by a user 18 indicating that the user's next action is to select a particular dynamic virtual object. Any of a wide variety of arbitrary user movements may be used as the predefined selection gesture. Upon recognizing a selection gesture, the hub 12 next looks for a follow-up gesture selecting one dynamic virtual object over others. This follow-up gesture may for example be pointing or eye gaze, though any of a variety of other follow-up gestures may be used. Having separate selection and follow-up gestures may reduce incorrect instances of virtual object selection. However, in further embodiments explained below with respect to step 748, the predefined selection gesture and follow-up gesture may instead be replaced by a gesture or body movement from which selection of a particular dynamic virtual object may be inferred.

A predefined interaction gesture in step 744 is a gesture performed by the user 18 that directly interacts with a particular dynamic virtual object. This direct interaction may for example be a gesture by the user to interact with a dynamic virtual object, such as for example performing a gesture to grab, push, pull or resize a particular dynamic virtual object. Where the dynamic virtual object is a virtual display slate 460, the direct interaction may alternatively be an interaction with the virtual content 462 displayed on the virtual display slate 460. This interaction may take a variety of forms, such as for example a user manipulating virtual controls on the virtual display slate to pause, rewind, fast-forward, change the volume or change the content of a displayed video. Instead of manipulating virtual controls, the user may perform predefined gestures which accomplish the same interactions.

Where the content is a user interface on a virtual display slate, the predefined interaction gesture may be interaction with the user interface. For example, a user may interact with the email user interface shown in the virtual display slate 460 in FIG. 8 by selecting and opening a received email. Where any of the above-described express interactions with a dynamic virtual object are detected by the hub 12, the hub selects that virtual object in step 762 as the user's focus.

It may be that no identifiable selection or interaction gesture is detected in step 744. In step 748, the hub 12 next looks for user movement or position from which it can be inferred that the user wishes to select a particular dynamic virtual object. In drawing the inference in step 748, the hub 12 may apply one or more refinement algorithms to strengthen or negate the inference.

One such refinement algorithm is to examine the position of the user's hand to determine a likelihood that the user is attempting to select or interact with a particular dynamic virtual object. For example, a user may be pointing at a particular dynamic virtual object, such as shown by the user 18 in FIG. 8. Even if not expressly pointing or performing an identifiable gesture, the user's hand may be close enough to a particular dynamic virtual object, or performing movements in the direction of a particular dynamic virtual object, so that the hub 12 can infer that the user wishes to select that virtual object.

Another refinement algorithm may check how long the user is pointing or holding a position adjacent a particular dynamic virtual object. For example, the user may simply be moving his hand to scratch his nose, or making some other movement unrelated to selecting a dynamic virtual object. Accordingly, the hub may infer selection of a particular dynamic virtual object if the user maintains the detected position for some predetermined period of time. The time may be two seconds in one example, but it may be longer or shorter than that in further embodiments.

If the refinement algorithms indicate selection of a dynamic virtual object in step 748, that object is selected in step 762. In further embodiments, the refinement algorithms may be omitted. In such embodiments, step 748 may identify a dynamic virtual object for selection if it is determined a user is pointing at the dynamic virtual object, or the user's hand is within a predetermined distance from the dynamic virtual object.

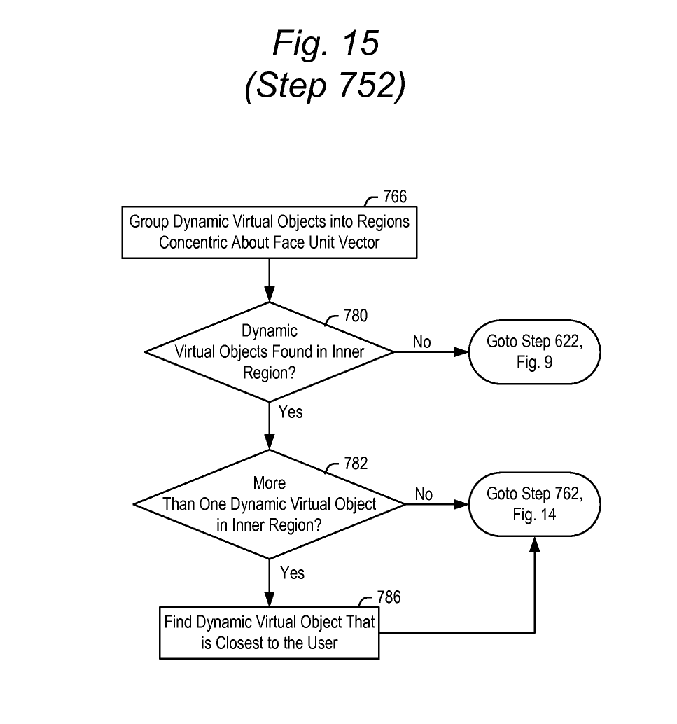

If no particular dynamic virtual object is identified from user position or movement in step 748, the system checks in step 752 whether selection of a dynamic virtual object can be inferred from the user's head position. As discussed above with respect to FIG. 11, a face unit vector may be defined as extending straight out from a plane of the user's face. An example is shown as face unit vector 466 in FIG. 8. Step 752 uses the face unit vector 466 to infer whether the user is selecting a particular dynamic virtual object. One embodiment of the operation of step 752 is now explained with reference to the flowchart of FIG. 15.

In step 766, all dynamic virtual objects may be grouped into discrete, non-overlapping regions concentric about the face unit vector 466. A first, closest annular region includes any dynamic virtual objects within a first predefined radial distance from the face unit vector 466 (regardless of distance away from the user). A second annular region includes any dynamic virtual objects between the first predefined radial distance from the face unit vector and a second predefined radial distance from the face unit vector, where the second radial distance is larger than the first. A third annular region includes any dynamic virtual objects between the second predefined radial distance from the face unit vector and a third predefined radial distance from the face unit vector, where the third radial distance is larger than the second. There may be more or less than three annular regions in further embodiments.

Step 780 next scans for any dynamic virtual objects in the first region. If none are found, the hub may infer that no dynamic virtual object is selected, and the flow may return to step 626 in FIG. 9. In alternative embodiments, if no dynamic virtual object is found in the first annular region, successive outer regions may be searched until one or more virtual objects are found.

Assuming a dynamic virtual object is found, step 782 checks whether there are more than one dynamic virtual objects in the closest annular region. If a single dynamic virtual object is found in the inner region, it may be inferred that the user desires to select that dynamic virtual object, and the object is selected in step 762 (FIG. 14). In further embodiments, the hub 12 may apply one or more refinement algorithms, for example requiring that the face unit vector 466 be relatively stable and still for a predetermined period of time to ensure that the user is, in fact, looking at the selected virtual object, and not just moving his head past the selected virtual object.

If, on the other hand, more than one dynamic virtual object is found in the closest annular region in step 782, the hub 12 looks for the dynamic virtual object in the first region that is closest to the user in step 786 (i.e., the virtual object which is the shortest distance away from the user along the face unit vector). That virtual object is selected as the object on which the user is focused in step 752. Again, one or more of the above refinement algorithms may be applied. One such refinement algorithm which may be used in step 752 is to examine the eye unit vector generated by the eye tracking assembly 134 which indicates where the user is looking. This may confirm or contradict a selection of a virtual object by examining the face unit vector described above.

In the embodiment described above, the annular regions are used instead of absolute radial distances from the face unit vector 466 to avoid the possibility of “focus fighting.” Focus fighting may occur when the hub 12 switches selection back and forth between two virtual objects that are close to the same radial distance away from the face unit vector 466. Each time a user moves his head slightly, the focus may undesirably shift back and forth between these two objects. As such, in embodiments, virtual object selection in step 752 may be determined by dividing the FOV into annular regions as described above. However, in further embodiments, absolute radial distances may be used, so that the dynamic virtual object closest to the face unit vector is selected as the virtual object the user is focused on.

It is understood that a variety of other heuristic algorithms may be applied in addition to those described above with respect to steps 744, 748 and 752 in further embodiments. As one further example, the hub 12 may not simply return a “yes” or “no” in steps 748 and 752, but may instead develop a confidence value from each of these steps. In such an embodiment, step 748 identifies a particular dynamic virtual object, together with a confidence value as to how likely it is that the user's position/movement is intended to select that particular dynamic virtual object.

The confidence value in step 748 may take into account a variety of factors, including for example: whether the user is pointing, gesturing or moving toward a specific virtual object; how long the user has held the pointing or other gesture; the proximity of a user's hand or limb to a specific dynamic virtual object; and whether there are other dynamic virtual objects in the vicinity of what appears to be the selected virtual object. Other factors may be used in addition to or instead of one or more of these factors.

Based on the examined factors, the hub 12 may determine an overall confidence value to infer whether the user has selected a specific dynamic virtual object. Some of these factors may be weighted more heavily than others in embodiments. For example, a user performing a recognized pointing or other gesture toward a specific virtual object, for at least a predetermined period of time, may be strong evidence of a user's desire to select that virtual object. As such, the factors relating to performance of recognizable gestures, and how long they are held, may be given more weight than others.

In embodiments using confidence values, step 752 identifies a particular dynamic virtual object, together with a confidence value as to how likely it is that the user's head position is intended to select that particular dynamic virtual object. The confidence value in step 752 may take into account a variety of factors, including for example: how long the user has maintained relatively the same face unit vector; how far away the selected virtual object is from the face unit vector; how far away the selected virtual object is from the user; and whether there are other dynamic virtual objects in the vicinity of what appears to be the selected virtual object. Other factors may be used in addition to or instead of one or more of these factors.

Based on the examined factors, the hub 12 may determine an overall confidence value to infer whether the user has selected a specific dynamic virtual object in step 752. Again, some of these factors may be weighted more heavily than others in embodiments.

Using confidence values, step 748 (selecting object based on hand position/movement) may often select the same virtual object as step 752 (selecting object based on head position). However, they may not select the same virtual object, for example where a user is pointing at one virtual object but looking at another. Where a conflict exists in the virtual object selected in steps 748 and 752, one may be given preference over the other. In embodiments, the object selected by examining user body position or movement in step 748 may be given preference over head position in step 752, but it may be the other way around in further embodiments.

Returning now to FIG. 13, if no dynamic virtual object is identified in step 722, the flow returns to step 626 (FIG. 9) without selecting a dynamic virtual object. On the other hand, if a dynamic virtual object is selected in step 722, that selected virtual object may be emphasized, repositioned and/or resized in step 724. For example, the selected dynamic virtual object may be emphasized by being displayed brighter, or with a border not provided on dynamic virtual objects not selected.

Step 724 may further include the step of repositioning the selected dynamic virtual object. For example, once selected, a dynamic virtual object may automatically move, rotate or resize as the user moves around within an environment to allow easy interaction with the selected dynamic virtual object. A dynamic virtual object may automatically rotate about one or more of the x, y, z axes so as to face the user. Thereafter, as the user moves, the selected dynamic virtual object may move with the user, remaining pinned in a fixed position within the user's FOV. Further details of such a system are set forth in U.S. patent application Ser. No. 13/485,511, entitled “Position Relative Hologram Interactions,” filed on May 31, 2012, which application is incorporated by reference herein in its entirety.

In addition to or instead of rotating to face a user, a selected dynamic virtual object may automatically translate along one or more of the x, y, z axes to a user-defined or default position for a selected dynamic virtual object. In addition to or instead of rotating/translating, the selected dynamic virtual object may automatically resize to a user-defined or default size within the user's FOV. The emphasis, repositioning and/or resizing of step 724 may be omitted in further embodiments.

Once a dynamic virtual object is selected, other non-selected virtual objects (dynamic or static) may be deemphasized in step 728. This may be accomplished by deemphasizing a non-selected virtual object. For example, a virtual object may be deemphasized by making it translucent (decreasing the alpha value in the opacity filter 114) and/or dimming the color of pixels forming a non-selected virtual object.

Where the non-selected dynamic virtual object is a virtual display slate displaying content, the content may additionally be deemphasized a number of ways. Where content on a non-selected virtual display slate is a video, the video may be turned off or paused. Any audio may be turned off, paused with the video or turned down. Where content on a non-selected virtual display slate is a still image, the image may be muted, though still images may not be deemphasized to the same degree as non-selected video in embodiments.

In embodiments described above, non-selected virtual objects may be deemphasized upon focus on a selected dynamic virtual object. However, it may be that a user is not focused on any virtual object. In such embodiments, all of the non-selected virtual objects may be deemphasized as described above. One exception to this may be where there is one dynamic virtual display slate 460 in the user's FOV. In this instance, it may be assumed that the user is generally focused on the single virtual display slate, even if the user looks away and loses focus momentarily. In this instance, the content on the single virtual display slate may continue until some predetermined period of time of non-focus has passed.

In addition, a user or application running on hub 12 may designate one or more dynamic virtual objects as exempt from the focus/defocus rules described herein that apply to other objects. For example, a virtual object may be set so as to have continuous focus, regardless of whether one or more users are looking at it or other virtual objects. One embodiment of this may be in a holographic sports bar environment including a virtual TV, for example on a virtual display slate, which is playing continuously. By policy, the TV's video should continue playing at full brightness even when a user is focused on another object. As a further example, a dynamic virtual object may be set up so that it does not get focus, even where one or more users are looking or pointing at it.

Moreover, in embodiments described above, focus is determined on a dynamic virtual object. In further embodiments, focus on a static virtual object, or a real world object, may also be determined in the manner described above. In the event of focus on a static virtual object or real world object, other virtual objects may be deemphasized as described above.

In a final step 732, the selected dynamic virtual object may be altered based on any perceived user interaction with the dynamic virtual object. For example, a user may adjust the settings of a selected virtual display slate 460 using predefined gestures. As indicated above, these gestures may be physical (hand or eye gaze) or verbal. The user may interact with virtual controls (knobs, switches, etc.) displayed on a virtual display slate to alter the displayed content or audio. The user can also reposition or resize the selected dynamic virtual object by grabbing, pushing, pulling, rotating, resizing or dropping the object. A variety of other user interactions are contemplated with the selected dynamic virtual objects.

In embodiments described above, the selected dynamic virtual object is a virtual display slate, but it may be otherwise in further embodiments. Dynamic virtual objects which do not display content may also be selected in accordance with the present technology. As one of many possible examples, virtual pets or other animals or animate objects may be displayed to the user via the head mounted display device 2. When a user looks at or points to a particular virtual pet, the pet may be selected. At that point, the image of the selected pet may approach the user or otherwise interact with the user. An ability to identify focus on a particular virtual object in accordance with the present technology allows for a wide variety of interactions with virtual objects which may be displayed to a user.

Returning now to FIG. 9, upon completion of user selection and interaction with a virtual object, the hub 12 may transmit the determined information to the one or more processing units 4 in step 626. The information transmitted in step 626 includes transmission of the scene map to the processing units 4 of all users. The transmitted information may further include transmission of the determined FOV of each head mounted display device 2 to the processing units 4 of the respective head mounted display devices 2. The transmitted information may further include transmission of static and dynamic virtual object characteristics, including the determined position, orientation, shape and appearance.

The processing steps 600 through 626 are described above by way of example only. It is understood that one or more of these steps may be omitted in further embodiments, the steps may be performed in differing order, or additional steps may be added. The processing steps 604 through 618 may be computationally expensive but the powerful hub 12 may perform these steps several times in a 60 Hertz frame. In further embodiments, one or more of the steps 604 through 618 may alternatively or additionally be performed by one or more of the one or more processing units 4. Moreover, while FIG. 9 shows determination of various parameters, and then transmission of these parameters all at once in step 626, it is understood that determined parameters may be sent to the processing unit(s) 4 asynchronously as soon as they are determined.

The operation of the processing unit 4 and head mounted display device 2 will now be explained with reference to steps 630 through 656. The following description is of a single processing unit 4 and head mounted display device 2. However, the following description may apply to each processing unit 4 and display device 2 in the system.

As noted above, in an initial step 656, the head mounted display device 2 generates image and IMU data, which is sent to the hub 12 via the processing unit 4 in step 630. While the hub 12 is processing the image data, the processing unit 4 is also processing the image data, as well as performing steps in preparation for rendering an image.

In step 634, the processing unit 4 may cull the rendering operations so that those virtual objects which could possibly appear within the final FOV of the head mounted display device 2 are rendered. The positions of other virtual objects may still be tracked, but they are not rendered. It is also conceivable that, in further embodiments, step 634 may be skipped altogether and the image is rendered.

The processing unit 4 may next perform a rendering setup step 638 where setup rendering operations are performed using the scene map and FOV received in step 626. Once virtual object data is received, the processing unit may perform rendering setup operations in step 638 for the virtual objects which are to be rendered in the FOV. The setup rendering operations in step 638 may include common rendering tasks associated with the virtual object(s) to be displayed in the final FOV. These rendering tasks may include for example, shadow map generation, lighting, and animation. In embodiments, the rendering setup step 638 may further include a compilation of likely draw information such as vertex buffers, textures and states for virtual objects to be displayed in the predicted final FOV.

Referring again to FIG. 9, using the information received from the hub 12 in step 626, the processing unit 4 may next determine occlusions and shading in the user's FOV in step 644. In particular, the screen map has x, y and z positions of objects in the scene, including moving and non-moving objects and the virtual objects. Knowing the location of a user and their line of sight to objects in the FOV, the processing unit 4 may then determine whether a virtual object partially or fully occludes the user's view of a real world object. Additionally, the processing unit 4 may determine whether a real world object partially or fully occludes the user's view of a virtual object. Occlusions are user-specific. A virtual object may block or be blocked in the view of a first user, but not a second user. Accordingly, occlusion determinations may be performed in the processing unit 4 of each user. However, it is understood that occlusion determinations may additionally or alternatively be performed by the hub 12.

In the context of the present technology, the processing unit 4 checks in step 644 whether a repositioned dynamic virtual object such as a virtual display slate 460 occludes or is occluded by another object. As noted above and explained below, the opacity filter 114 allows virtual display slate 460 to be displayed while blocking light from virtual and real world object that appear behind the virtual display slate 460 (from the user's point of view). The virtual display slate 460 may be occluded by object appearing closer to the user that virtual display slate 460. In that case, the user may do nothing (and leave the virtual display slate 460 occluded), or the user may reposition the virtual display slate 460 in front of the occluding object. In this instance, the virtual display slate 460 may be made smaller to maintain the same perspective of the virtual display slate 460 to the user.

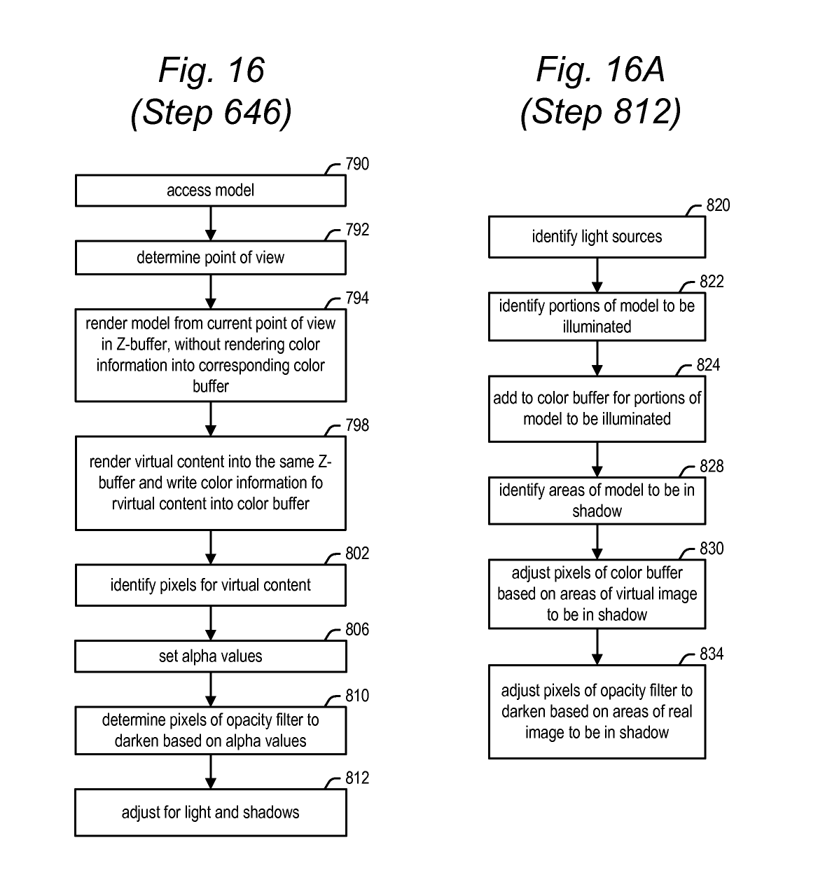

In step 646, the GPU 322 of processing unit 4 may next render an image to be displayed to the user. Portions of the rendering operations may have already been performed in the rendering setup step 638 and periodically updated. Further details of the rendering step 646 are now described with reference to the flowchart of FIGS. 16 and 16A. FIGS. 16 and 16A are described with respect to an example of rendering a virtual display slate 460, though the following steps apply to rending all virtual objects, both static and dynamic.

In step 790 of FIG. 16, the processing unit 4 accesses the model of the environment. In step 792, the processing unit 4 determines the point of view of the user with respect to the model of the environment. That is, the system determines what portion of the environment or space the user is looking at. In one embodiment, step 792 is a collaborative effort using hub computing device 12, processing unit 4 and head mounted display device 2 as described above.

In one embodiment, the processing unit 4 will attempt to add one or more virtual display slates 460 into a scene. In step 794, the system renders the previously created three dimensional model of the environment from the point of view of the user of head mounted display device 2 in a z-buffer, without rendering any color information into the corresponding color buffer. This effectively leaves the rendered image of the environment to be all black, but does store the z (depth) data for the objects in the environment. Step 794 results in a depth value being stored for each pixel (or for a subset of pixels).

In step 798, virtual content (e.g., virtual images corresponding to the virtual display slates 460) is rendered into the same z-buffer and the color information for the virtual content is written into the corresponding color buffer. This effectively allows the virtual display slates 460 to be drawn on the headset microdisplay 120 taking into account real world objects or other virtual objects occluding all or part of a virtual display slate.

In step 802, the system identifies the pixels of microdisplay 120 that display virtual display slates. In step 806, alpha values are determined for the pixels of microdisplay 120. In traditional chroma key systems, the alpha value is used to identify how opaque an image is, on a pixel-by-pixel basis. In some applications, the alpha value can be binary (e.g., on or off). In other applications, the alpha value can be a number with a range. In one example, each pixel identified in step 802 will have a first alpha value and all other pixels will have a second alpha value.

In step 810, the pixels for the opacity filter 114 are determined based on the alpha values. In one example, the opacity filter 114 has the same resolution as microdisplay 120 and, therefore, the opacity filter can be controlled using the alpha values. In another embodiment, the opacity filter has a different resolution than microdisplay 120 and, therefore, the data used to darken or not darken the opacity filter will be derived from the alpha value by using any of various mathematical algorithms for converting between resolutions. Other means for deriving the control data for the opacity filter based on the alpha values (or other data) can also be used.

In step 812, the images in the z-buffer and color buffer, as well as the alpha values and the control data for the opacity filter, are adjusted to account for light sources (virtual or real) and shadows (virtual or real). More details of step 812 are provided below with respect to FIG. 16A. The process of FIG. 16 allows for automatically displaying a virtual display slate 460 over a stationary or moving object (or in relation to a stationary or moving object) on a display that allows actual direct viewing of at least a portion of the space through the display.

FIG. 16A is a flowchart describing one embodiment of a process for accounting for light sources and shadows, which is an example implementation of step 812 of FIG. 16. In step 820, processing unit 4 identifies one or more light sources that may be accounted for. For example, a real light source may be accounted for when drawing a virtual image. If the system is adding a virtual light source to the user's view, then the effect of that virtual light source can be accounted for in the head mounted display device 2 as well. In step 822, the portions of the model (including virtual objects) that are illuminated by the light source are identified. In step 824, an image depicting the illumination is added to the color buffer described above.

In step 828, processing unit 4 identifies one or more areas of shadow that may be added by the head mounted display device 2. For example, if a virtual object is added to an area in a shadow, then the shadow may be accounted for when drawing the virtual object by adjusting the color buffer in step 830. If a virtual shadow is to be added where there is no virtual object, then the pixels of opacity filter 114 that correspond to the location of the virtual shadow are darkened in step 834.

In conjunction with a rendered image, the hub computing system may also provide audio over the speakers 25 (FIG. 1). The audio may be associated with a scene in general. Alternatively or additionally, the audio may be associated with a specific virtual object. Where associated with a specific virtual object, the audio may have a directional component. Thus, where two users are viewing a virtual object having associated audio, the object being to the left of a first user and to the right of the second user, the corresponding audio will appear to come from the left of the first user and to the right of the second user. This effect may be generated by spatially separated speakers 25. While FIG. 1 shows two speakers 25, there may be more than two speakers in further embodiments.

Returning to FIG. 9, in step 650, the processing unit checks whether it is time to send a rendered image to the head mounted display device 2, or whether there is still time for further refinement of the image using more recent position feedback data from the hub 12 and/or head mounted display device 2. In a system using a 60 Hertz frame refresh rate, a single frame is about 16 ms.

In particular, the composite image based on the z-buffer and color buffer (described above with respect to FIGS. 16 and 16A) is sent to microdisplay 120. That is, the images for the one or more virtual display slates 460 are sent to microdisplay 120 to be displayed at the appropriate pixels, accounting for perspective and occlusions. At this time, the control data for the opacity filter is also transmitted from processing unit 4 to head mounted display device 2 to control opacity filter 114. The head mounted display would then display the image to the user in step 658.

On the other hand, where it is not yet time to send a frame of image data to be displayed in step 650, the processing unit may loop back for more updated data to further refine the predictions of the final FOV and the final positions of objects in the FOV. In particular, if there is still time in step 650, the processing unit 4 may return to step 608 to get more recent sensor data from the hub 12, and may return to step 656 to get more recent sensor data from the head mounted display device 2.

The processing steps 630 through 652 are described above by way of example only. It is understood that one or more of these steps may be omitted in further embodiments, the steps may be performed in differing order, or additional steps may be added.

Moreover, the flowchart of the processor unit steps in FIG. 9 shows all data from the hub 12 and head mounted display device 2 being cyclically provided to the processing unit 4 at the single step 634. However, it is understood that the processing unit 4 may receive data updates from the different sensors of the hub 12 and head mounted display device 2 asynchronously at different times. The head mounted display device 2 provides image data from cameras 112 and inertial data from IMU 132. Sampling of data from these sensors may occur at different rates and may be sent to the processing unit 4 at different times. Similarly, processed data from the hub 12 may be sent to the processing unit 4 at a time and with a periodicity that is different than data from both the cameras 112 and IMU 132. In general, the processing unit 4 may asynchronously receive updated data multiple times from the hub 12 and head mounted display device 2 during a frame. As the processing unit cycles through its steps, it uses the most recent data it has received when extrapolating the final predictions of FOV and object positions.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. It is intended that the scope of the invention be defined by the claims appended hereto.

We claim:

1. A system for presenting a mixed reality experience to one or more users, the system comprising:
a display device for a user, the display device including a display unit for displaying one or more virtual objects to the user of the display device; and
a computing system operatively coupled to the display device, the computing system generating the one or more virtual objects for display on the display device, the computing system determining selection of a virtual object from the one or more virtual objects by inferring interaction of the user with the virtual object based on at least one of determining a position of the user's head with respect to the virtual object, determining a position of the user's eyes with respect to the virtual image, determining a position of the user's hand with respect to the virtual object, and determining a movement of the user's hand with respect to the virtual object.

2. The system of claim 1, the computing system comprises at least one of a hub computing system and one or more processing units.

3. The system of claim 1, the computing system determining whether the user's hand is pointing at the virtual object in basing the inference on a position of the user's hand with respect to the virtual object.

4. The system of claim 1, the computing system using a vector straight out from the user's face in basing the inference on determining a position of the user's head with respect to the virtual object.

5. The system of claim 1, the computing system giving greater weight to a position of the user's hand with respect to the first virtual object than a position of the user's head with respect to the virtual object in determining selection of the virtual object.

6. The system of claim 1, wherein the virtual object is a virtual display slate displaying static content or video content.

7. The system of claim 1, wherein the virtual object is a virtual display slate displaying a graphical user interface.

8. A method of presenting a mixed reality experience to one or more users, the method comprising:
(a) displaying first and second virtual objects to a user in the user's field of view;
(b) determining at least one of a position of the user's hand and a position of the user's head;
(c) inferring selection of the first virtual object based on the determination of said step (b); and
(d) deemphasizing the second virtual object relative to the first virtual object upon inferring selection of the first virtual object in said step (c).

9. The method of claim 8, wherein said step (a) of displaying first and second virtual objects comprises the step of displaying a first virtual object that is a dynamic virtual object with which the user can interact.

10. The method of claim 8, wherein said step (a) of displaying first and second virtual objects comprises the step of displaying a first virtual object that is a real world object.

11. The method of claim 8, wherein said step (c) of inferring selection of the first virtual object comprises basing the inference on a determination in said step (b) that the user is pointing at the first virtual object.

12. The method of claim 8, wherein said step (c) of inferring selection of the first virtual object comprises basing the inference on a determination in said step (b) that the user's hand is within a predefined distance of the first virtual object for a predefined period of time.

13. The method of claim 8, wherein said step (c) of inferring selection of the first virtual object comprises basing the inference on at least one of a determination in said step (b) that the user's head is facing the first virtual object, and a determination in said step (b) that the user's eyes are facing the first virtual object.

14. The method of claim 8, wherein said step (d) of deemphasizing the second virtual object relative to the first virtual object comprises at least one of: i) decreasing an opacity of the second virtual object so that the second virtual object is displayed with a degree of opacity, ii) dimming the color of pixels forming the second virtual object, iii) stopping a video displayed on the second virtual object, and iv) muting audio emanating from the second virtual object.

15. The method of claim 8, wherein said step (a) of displaying first and second virtual objects comprises the step of displaying the first virtual object as a first virtual display slate displaying a first content, and displaying the second virtual object as a second virtual display slate displaying a second content.

16. The method of claim 16, wherein said step (d) of deemphasizing the second virtual object relative to the first virtual object comprises the step of pausing a video displayed as the second content on the second virtual display slate.

17. The method of claim 16, wherein said step (d) of deemphasizing the second virtual object relative to the first virtual object comprises at least one of pausing an audio and reducing a volume of an audio presented with the second content on the second virtual display slate.

18. A method of presenting a mixed reality experience to one or more users, the method comprising:
(a) displaying first and second virtual objects to a user in the user's field of view;
(b) setting the first virtual object as the object on which the user is focused upon determining the user has performed an express gesture indicating selection of the first virtual object;
(c) setting the first virtual object as the object on which the user is focused upon determining the user is pointing at the first virtual object for a predetermined period of time;
(d) setting the first virtual object as the object on which the user is focused upon determining the user's head is facing in a direction of the first virtual object; and
(e) deemphasizing the second virtual object relative to the first virtual object upon setting the first virtual object as the object on which the user is focused in one of said steps (b), (c) and (d).

19. The method of claim 18, wherein said step (d) comprises the steps of:
(f) defining a vector extending from a face of the user;
(g) defining first and second non-overlapping annular regions concentric about the vector defined in said step (a), the first annular region being closer to the vector than the second annular region;
(h) determining whether at least one of the first and second virtual objects reside in the first annular region;
(i) setting the first virtual object as the object on which the user is focused upon determining that the first virtual object is in the first annular region and the second virtual object is not; and
(j) setting the first virtual object as the object on which the user is focused upon determining that the first and second virtual objects are in the first annular region, and the first virtual object is closer to the user than the second virtual object.

20. The method of claim 18, further comprising the step k) of setting the second virtual object as the object on which the user is focused instead of the first virtual object upon at least one of: i) detecting a change in the user's hand position to point at the second virtual object instead of the first virtual object, and ii) detecting a change in the user's head position to face in the direction of the second virtual object instead of the first virtual object, said step k) resulting in deemphasizing the first virtual object relative to the second virtual object.
